(19) United States
(12) Patent Application Publication
(10) Pub. No.: US 2015/0186925 A1
(43) Pub. Date: Jul. 2, 2015

(54) MEDIA SPEND OPTIMIZATION USING ENGAGEMENT METRICS IN A CROSS-CHANNEL PREDICTIVE MODEL

(71) Applicants: Anto Chittilappilly, Waltham, MA (US); Darius Jose, Thrissur (IN)

(72) Inventors: Anto Chittilappilly, Waltham, MA (US); Darius Jose, Thrissur (IN)

(21) Appl. No.: 14/584,494

(22) Filed: Dec. 29, 2014

Related U.S. Application Data
(60) Provisional application No. 61/922,680, filed on Dec. 31, 2013.

(51) Int. Cl. G06Q 30/02

(52) U.S. Cl. CPC G06Q 30/0242

(57) ABSTRACT

A series of techniques, methods, systems, and computer program products for advertising portfolio management is disclosed herein. More specifically, the herein disclosed techniques enable receiving data comprising a plurality of marketing stimulations, and receiving data comprising a plurality of engagement metrics. The received data is analyzed to determine a set of engagement weights associated with the engagement metrics. The determined engagement weights are in turn used to calculate the effectiveness of particular marketing stimulations through a set of marketing channels. Additional data in the form of measured responses (e.g., sales figures, survey results, etc.) are used to form a learning model wherein the learning model comprises one or more of, a stimulus-response predictor, a stimulus-engagement predictor, and an engagement-response predictor. The predictors can be combined into a cascade of models for determining the effectiveness of marketing stimulations on consumer engagement, and for determining effectiveness of marketing stimulations on measured responses.

### RELATED APPLICATIONS

This application claims priority, under 35 U.S.C. §119(e), to U.S. Provisional Application No. 61/922,680, filed on Dec. 31, 2013, entitled “MEDIA SPEND OPTIMIZATION USING ENGAGEMENT METRICS IN A CROSS-CHANNEL PREDICTIVE MODEL”, which is expressly incorporated herein by reference.

### FIELD OF THE INVENTION

The disclosure relates to the field of advertising portfolio management and more particularly to techniques for media spend optimization using engagement metrics in a cross-channel predictive model.

### BACKGROUND

Advertisers promote their brands and products any way they can—from word-of-mouth advertising to Super Bowl ads. Indeed, advertising is big business. In today's global commerce arena, business managers are motivated to consider how to improve the effectiveness of the marketing channels used to tout their products or services. Modern marketing campaigns employ a large set of advertising channels (e.g., TV, radio, print, mail, web, etc.) into which marketing resources are allocated. Often a marketing and advertising campaign will use multiple channels, each with a specific objective to establish brand awareness, entice the consumer, and convert advertising into one or more forms of user actions (e.g., effect a product purchase, a click on or through an impression, etc.). Some advertising channels capture a direct correspondence between an ad placement and an action, and some do not. For example, contrast a TV ad placement with a web page ad (e.g., banner ad, display ad, click-on coupon, etc.). In the web page case, the precise distribution of the internet ad placements can be determined by the internet ad network provider since at the time an internet ad is displayed, quite a lot is known about the placement. In the TV case, while it can be known that the ad placement was broadcast, it might not be known precisely who saw the ad.

For managing spend on advertising, advertisers want to know quite specifically how a particular ad placement resulted in a particular behavior by the viewer. In the domain of internet advertising, the details such as the location where the ad was placed, the time of day the ad was placed, responses or actions taken after the placement (e.g., click on an ad or coupon) or, in some cases, precise demographics of the respondent can be known and can thus be delivered to the advertiser. However, when using many other forms of media, it is often collectable only in aggregate. Yet, advertisers strongly desire a level of precision in the form of a specific placement such that the respective answers to “who, what, when” can be used by advertisers to tune their creatives and/or tune their placements so as to improve brand awareness, and/or entice the consumer and/or convert advertising into action.

Prior to the advent of internet advertising, a common expression repeated in advertising circles was, “Half the money I spend on advertising is wasted; the trouble is, I don't know which half.” This expression (often attributed to John Wanamaker, b. 1838) illustrates how difficult it is to measure the effectiveness of traditional broadcast or mass advertising. The problem of determining the effect of one or another type of traditional broadcast or mass advertising (e.g., by media, by channel, by time-of-day, etc.) has long been studied, yet legacy approaches fall short. Legacy approaches rely on a naïve one-to-one correspondence between an advertising placement and a measured response. If an increase in a particular spend (e.g., a radio spot) results in more responses (e.g., calls to the broadcasted 1-800 number), then a legacy approach would recommend to the advertiser to increase spend on those radio spots. Conversely, if spending on direct mailings did not return any leads, then a legacy approach would recommend to the advertiser to decrease spend on such direct mailings. Such legacy approaches are naïve in at least the following aspects:
Cross-channel influence. For example, the effect of spend on one channel might influence the effectiveness of another channel.
Constraints and limits. Additional spending on a particular channel suffers from diminishing returns (e.g., the audience “tunes out” after hearing a message too many times). This can also be described as a channel saturation characteristic.
Engagement metrics. Legacy approaches fail to incorporate surveys or other engagement metrics that can serve to establish a statistically measurable relationship between the effect of spending and viewer/consumer response in the form of brand awareness, brand preferences, and/or other brand sentiment.

Of course, an advertiser would want to accurately predict the overall effectiveness of a particular change in advertising spending, yet legacy prediction models fail to account for the aforementioned cross-channel effects, constraints, and effects of consumer engagement variables. Moreover, an advertiser would want to make changes in advertising spending in order to achieve desired outcomes.

What is needed is a technique or techniques for managing media spending that considers consumer engagement variables when forming predictions. Indeed, none of the aforementioned legacy approaches achieve the capabilities of the herein-disclosed techniques for media spend optimization using engagement metrics in a cross-channel predictive model. There is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for media spend optimization using engagement metrics in a cross-channel predictive model.

A method, system, and computer program product for advertising portfolio management is disclosed herein. More specifically, the herein disclosed techniques enable receiving data comprising a plurality of marketing stimulations, and receiving data comprising a plurality of engagement metrics. The received data is analyzed to determine a set of engagement weights associated with the engagement metrics. The determined engagement weights are in turn used to calculate the effectiveness of particular marketing stimulations through a set of marketing channels. Additional data in the form of measured responses (e.g., sales figures, survey results, etc.) are used to form a learning model wherein the learning model comprises one or more of, a stimulus-response predictor, a stimulus-engagement predictor, and an engagement-response predictor. The predictors can be combined into a cascade of models for determining the effectiveness of marketing stimulations on consumer engagement and for determining effectiveness of marketing stimulations on measured responses (e.g., sales figures, survey results, etc.). The marketing campaign can comprise stimulations quantified as a number of direct mail pieces, a number or frequency of TV spots, a number of web impressions, a number of coupons printed, etc.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts a progression from stimulation to engagement to response as used in practicing media spend optimization using engagement metrics, according to some embodiments.

FIG. 1B depicts an environment for constructing and using a mixed media predictive model, according to some embodiments.

FIG. 1C depicts an environment for constructing and using a cross-channel predictive model using engagement metrics in, according to some embodiments.

FIG. 1D depicts an environment for practicing media spend optimization using a cross-channel predictive model, according to some embodiments.

FIG. 1E depicts an environment for practicing media spend optimization using engagement metrics in a cross-channel predictive model, according to some embodiments.

FIG. 2A presents a portfolio schematic showing multiple channels as used in systems for media spend optimization using a cross-channel predictive model, according to some embodiments.

FIG. 2B presents a portfolio schematic showing multiple channels as used in systems for media spend optimization using engagement metrics in a cross-channel predictive model, according to some embodiments.

FIG. 3 depicts a multi-channel campaign execution plan to be prosecuted using media spend optimization using engagement metrics in a cross-channel predictive model, according to some embodiments.

FIG. 4A is a chart depicting vectors formed from time-series of scalars as used in forming a cross-channel predictive model, according to some embodiments.

FIG. 4B is a correlation chart showing time-based and value-based correlations as used to form a cross-channel predictive model, according to some embodiments.

FIG. 5A depicts an unsupervised model training flow resulting in a baseline trained model, according to some embodiments.

FIG. 5B depicts a supervised model validation flow resulting in a learning model, according to some embodiments.

FIG. 6A and FIG. 6B depict a model development flow and a simulation model development flow used to develop simulation models for use in systems for media spend optimization using engagement metrics in a cross-channel predictive model, according to some embodiments.

FIG. 7 depicts a true score data structure used in systems for media spend optimization using engagement metrics in a cross-channel predictive model, according to some embodiments.

FIG. 8 is a block diagram of a subsystem for populating a true score data structure as used in systems for media spend optimization using engagement metrics in a cross-channel predictive model, according to some embodiments.

FIG. 9 is a block diagram of a subsystem for calculating cross-channel contributions as used in systems for media spend optimization using engagement metrics in a cross-channel predictive model, according to some embodiments.

FIG. 10 is a data flow diagram for generating true scores using cross-channel engagement metrics and responses, according to some embodiments.

FIG. 11 depicts a true metrics report for practicing media spend optimization using engagement metrics in a cross-channel predictive model, according to some embodiments.

FIG. 12 is a block diagram of a system for optimizing media spend using a cross-channel predictive model, according to some embodiments.

FIG. 13 is a block diagram of a system for media spend optimization using engagement metrics in a cross-channel predictive model, according to some embodiments.

FIG. 14 depicts a block diagram of an instance of a computer system suitable for implementing an embodiment of the present disclosure.

### DETAILED DESCRIPTION

### Overview

Consumers that journey from media stimulation to some action (e.g., click-through, conversion, purchase decision, etc.) usually go through multiple steps involving awareness, perception, sentiments, and actions at multiple levels. The term “conversion funnel” is often used to refer to this journey. Different media used in advertising operates at multiple points throughout the funnel. For example TV, radio, and print are often regarded as “top of the funnel” stimulation points while search is considered a “bottom of the funnel” activity since it is implied that the consumer searching for a product is at a much higher level of readiness to make a “buy” decision than the consumer passively exposed to a TV advertisement.

As is discussed in detail herein, incorporation of various measures (e.g., engagement metrics) facilitates the construction of highly accurate models. Such models incorporate measurements taken along a consumer's journey, and such models can be used to gain insight into cause and effect (not merely stimulus and response) of transitions through various stages in the funnel.

In many forms of advertising media, stimulus and response can be measured only indirectly or can be determined only in aggregate. For example, a radio ad in the form of “Call 1-800-123-4567 today for this buy-one-get-two-free offer” might be broadcasted to three million morning commuters, but which specific commuters have heard the spot cannot be determined directly. Indirectly, however the effectiveness of the spot can be measured by tallying the number of calls into “1-800-123-4567”. Or, again indirectly, the effectiveness of the spot can be measured by running an experiment to see if an increase in the frequency of the radio spots entices commensurately more listeners to send in a “prepaid inquiry postcard” they received in a direct mailing.

The problem of determining the effect of one or another type of advertising (e.g., by media, by channel, by time-of-day, etc.) has long been studied, yet legacy approaches fall short. Legacy approached rely on a naïve one-to-one correspondence between an advertising placement and a measured response. If an increase in a particular spend (e.g., a radio spot) results in more responses (e.g., more calls to the broadcasted 1-800 number) then a legacy approach would recommend to the advertiser to increase spend on those radio spots. Conversely, if spending on direct mailings did not return any leads, then a legacy approach would recommend to the advertiser to decrease or eliminate spending on such direct mailings. Such legacy approaches are naïve in at least that they fail to consider the following aspects:
Cross-channel influence from more spending. For example, the effect of spending more on TV ads might influence viewers to “log in” (e.g., to access a website) and take a survey or download a coupon.
Cross-channel effects that are counter-intuitive in a single channel model. For example, additional spending on a particular channel often suffers from measured diminishing returns (e.g., the audience “tunes out” after hearing a message too many times). Placement of a message can reach a “saturation point” beyond which point further behavior is not measured (in the same channel). However, additional spending beyond the single-channel saturation point may correlate to improvements in other channels.
Engagement metrics. Legacy approaches fail to incorporate surveys or other engagement metrics that can serve to establish a statistically-measurable relationship between the effect of spending and viewer/consumer response in the form of brand awareness, brand preferences, and/or other brand sentiments.

An advertiser would want to accurately predict the overall effectiveness of a particular change in the advertiser's ad placement portfolio, yet legacy prediction models fail to account for the aforementioned engagement metrics and cross-channel effects.

The influence of a particular stimulus on consumer engagement, and associated cross-channel effects, becomes complex quickly. An advertiser's portfolio might be comprised of a mixture of many placements across a mixture of media outlets, and the advertiser might sponsor many tests and surveys in order to measure the influence of a particular stimulus on consumer engagement. In typical scenarios, an advertiser would advertise using several channels, where each channel is intended to deliver a particular effect. Strictly as examples, the effects considered by advertisers can be classified into three categories:
introducers,
influencers, and
converters.

Continuing this example, introducers provide the first exposure of a brand, product, or promotion to a consumer. An influencer keeps the advertised brand, product, or promotion at the forefront of the consumer's consciousness. Converters directly provoke a user to purchase the advertised product or service. For example, an Internet advertisement may offer a discount to consumers who purchase the advertised product by clicking the advertisement. Each of these types of channels and their respective stimuli have unique strengths and weaknesses, and a mixture of such channels and their respective stimuli are often found in successful advertising spend portfolios. Commonly, the mixture of channels and their respective stimuli encompass many tens or hundreds (or more) of placements, each having an associated measurement technique. When considering that changing spend in one channel would affect or influence a second channel, and that influences on the second channel might in turn affect a third channel, and so on, it becomes clear that a naïve model falls short.

Advertisers want to accurately predict the overall effectiveness of a portfolio of spends. In particular, advertisers want to accurately forecast the overall effectiveness of a mix of advertising spending (e.g., a portfolio of spends) given a proposed change in spending into one or more channels.

Disclosed herein are modeling techniques that consider the influence of a particular stimulus on consumer engagement, and further, the disclosed techniques include modeling of both intra-channel effects (e.g., saturation, amplification) as well as inter-channel or cross-channel effects. Also, disclosed herein are modeling and simulation techniques that result in simulation scenarios that accurately forecast consumer engagement, as well as the overall effectiveness of a media spending portfolio, given a proposed change in the media spending ratios in the portfolio.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

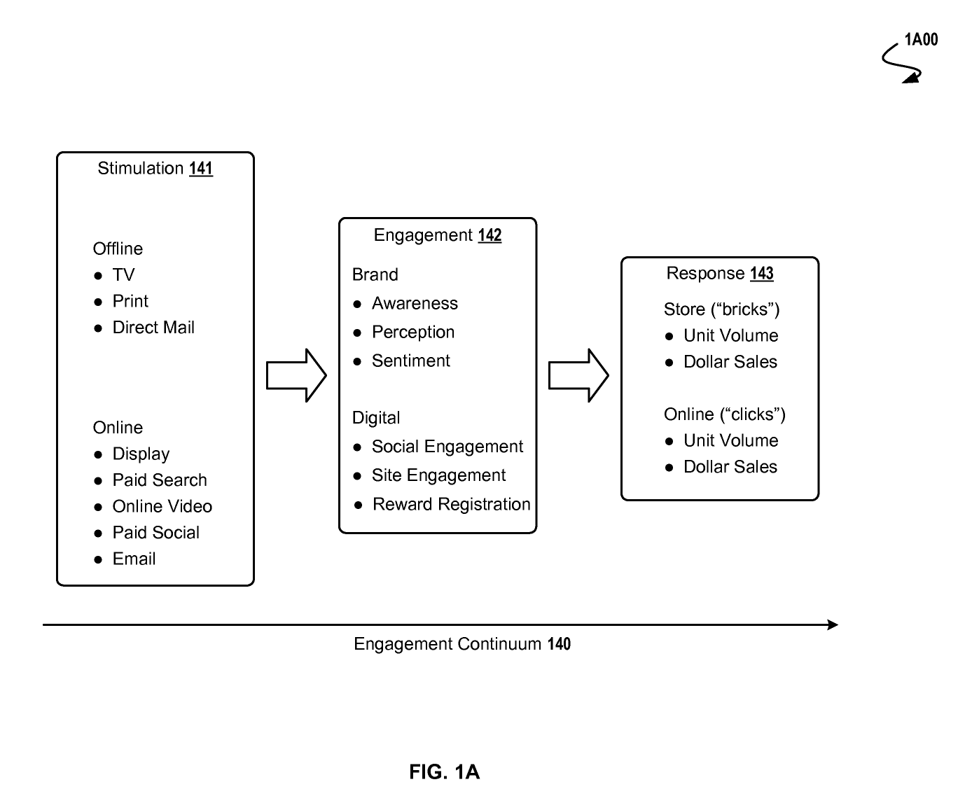

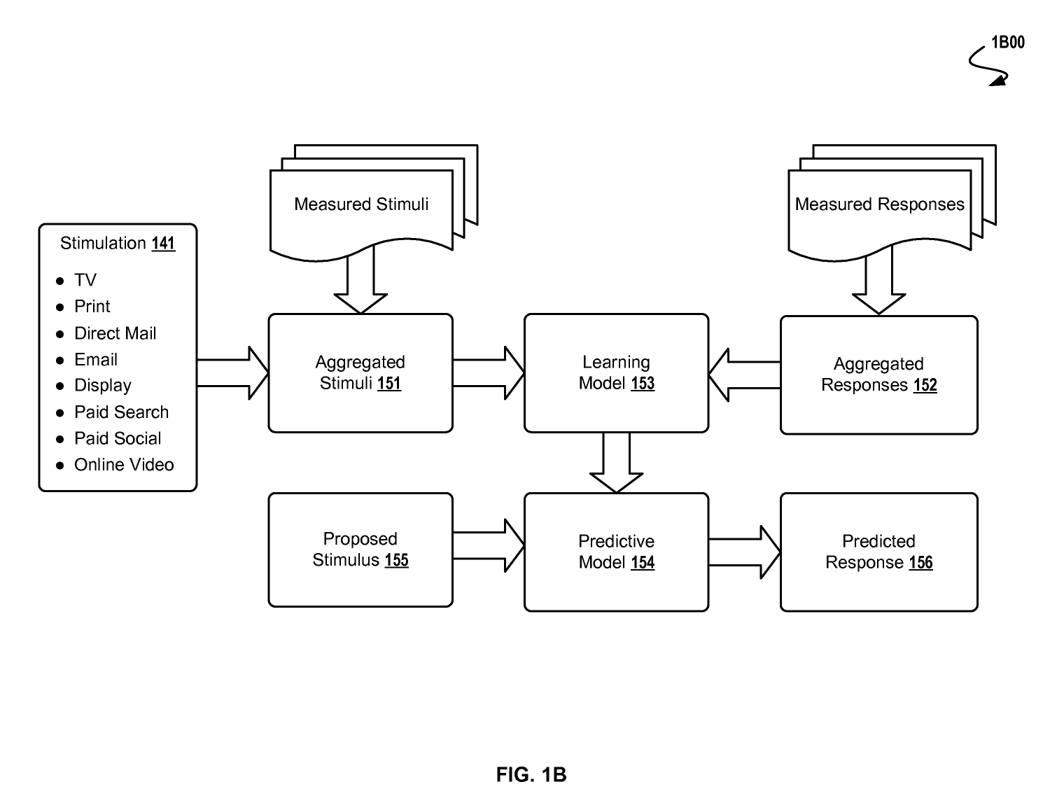

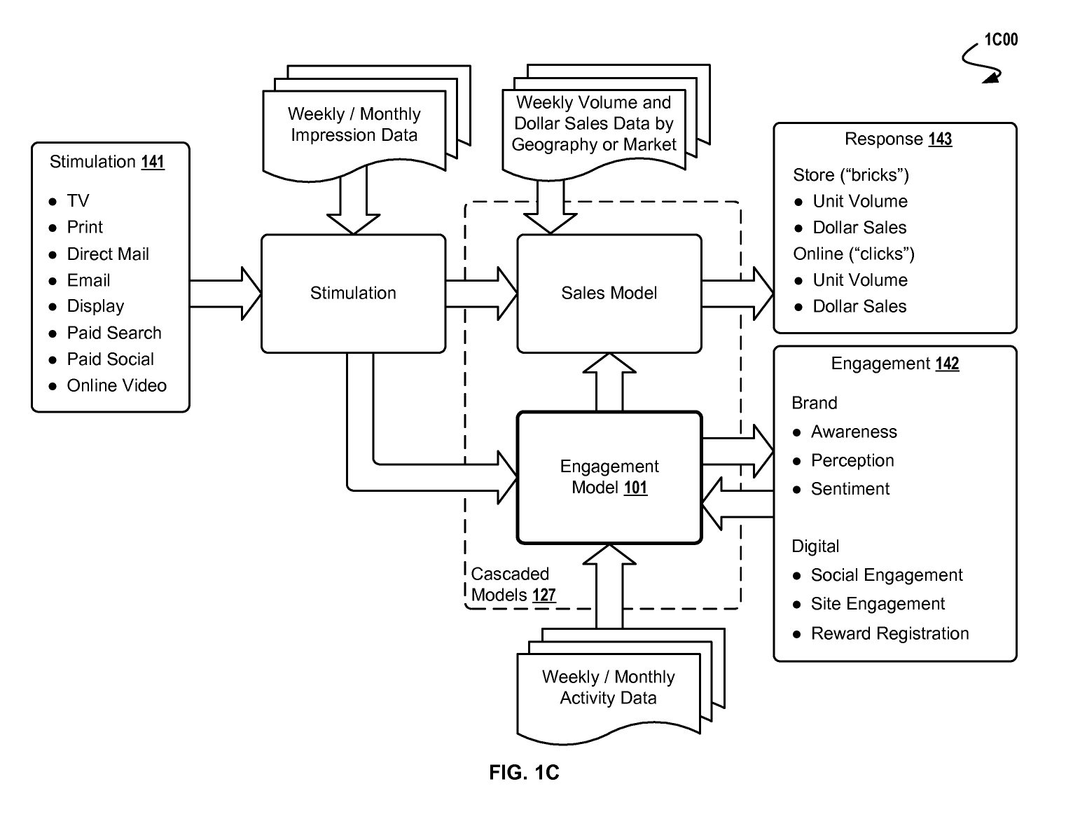

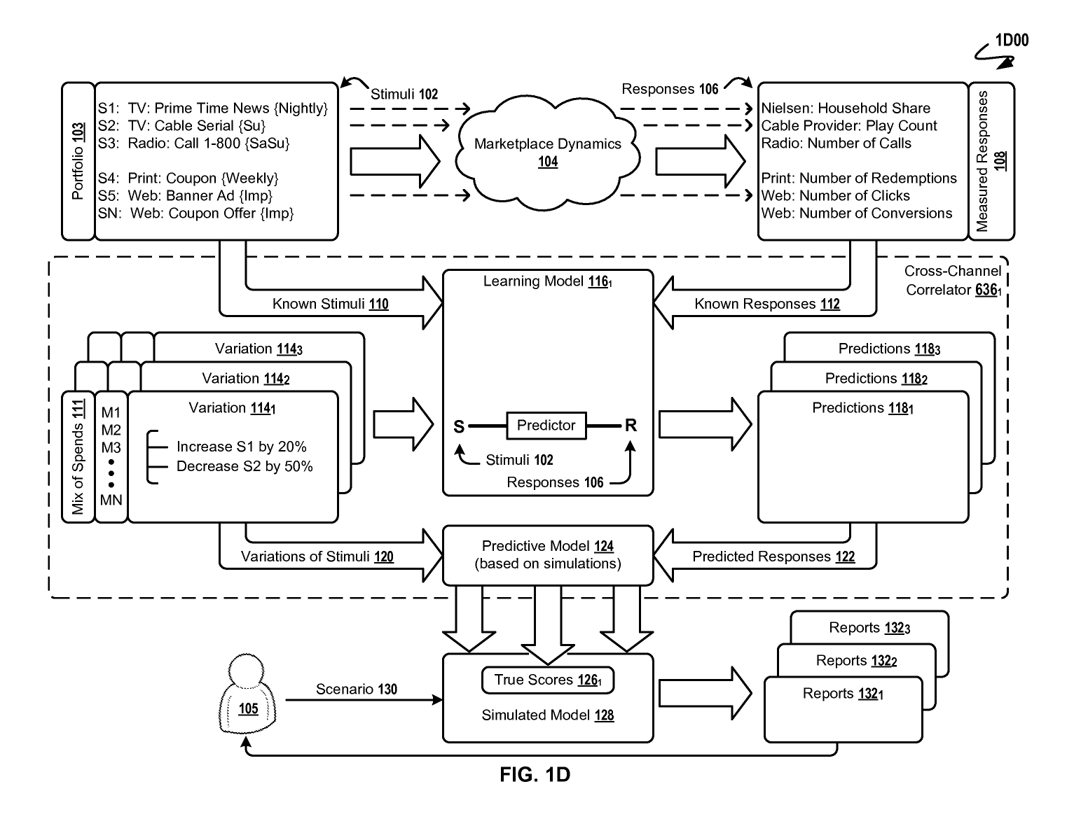

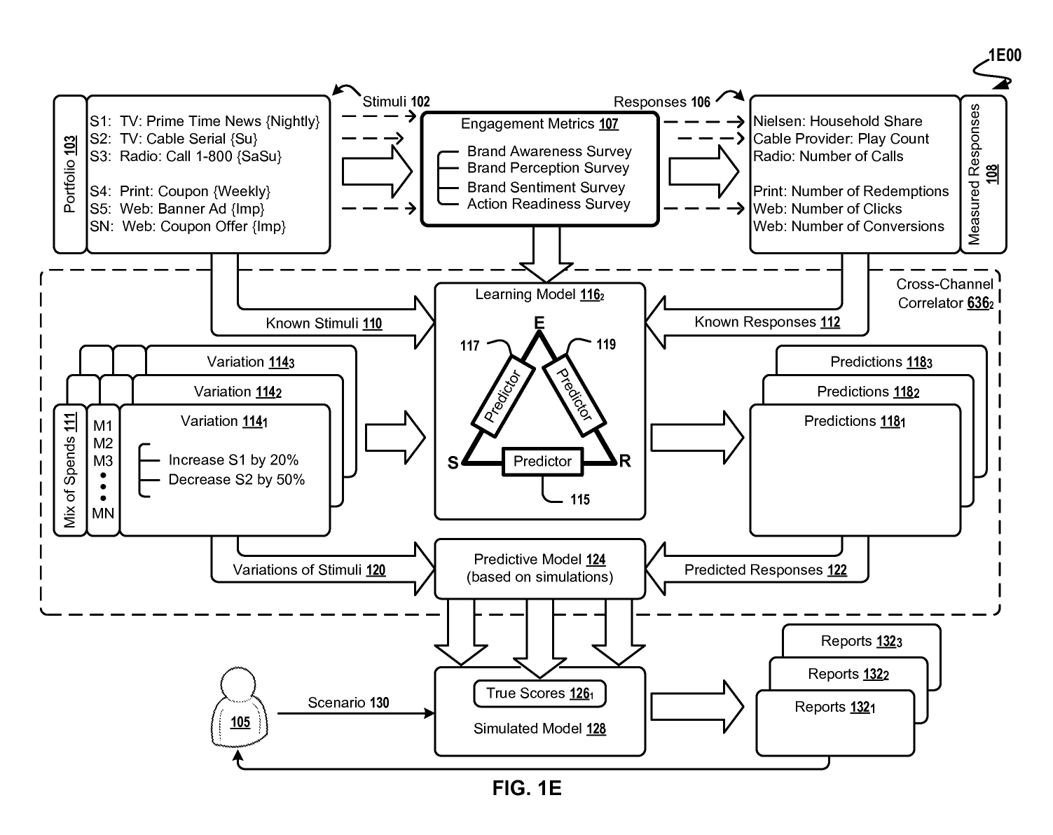

FIG. 1A depicts a progression 1A00 from stimulation to engagement to response as used in practicing media spend optimization using engagement metrics. The shown graphic depicts a traversal through an engagement continuum 140. A stimulation 141 (e.g., placement of offline and online advertisements) can result in an engagement 142 (e.g., awareness), and some forms of engagement can produce a response 143 (e.g., a purchase at a store or online). In accordance with the herein-disclosed modeling techniques, a predictive model can be developed and such a model can calculate quantitative relationships between stimulus in a particular channel and quantitatively measured responses by a respondent (e.g., a consumer who makes a purchase). Further the stimulation in one type of media (e.g., a TV advertisement) can improve the performance of other media (e.g., better response rate from a direct mailer), and such mixed media effects can be quantified so as to be used in a predictive model.

FIG. 1B depicts an environment 1B00 for constructing and using a mixed media predictive model, according to some embodiments. As shown, a set of aggregated responses 152 can be correlated to a set of aggregated stimuli 151 (e.g., measured and actual) by a learning model 153. The learning model 153 can be developed and used by a predictive model 154 to produce a predicted response 156 from a proposed stimulus 155. Since the learning model 153 considers an aggregate of stimuli and responses from multiple media channels, the predictive model 154 can account for mixed media effects. As an example, the predictive model 154 can predict the overall marketplace response (e.g., in multiple media channels) to a change in stimulus in a single channel (e.g., more TV advertising).

However, correlation between the aggregated stimuli 151 and the aggregated responses 152 does not go so far as to indicate a cause and effect relationship. What is needed is more data between stimulus and response such that modeling and analysis can derive statistical relationships between a specific class of responses and a specific class of stimuli. Strictly as some examples, if a particular user's internet search for a particular product results in that same user's click on an internet advertisement for that product, and the user purchases that particular product in the same session, it is reasonable to draw a relationship between the stimulation of the placement of the advertisement and the user's buy decision. While this specificity of data is sometimes available (e.g., in an internet setting), there are many cases where the aggregate effect of a particular stimulation of a market (e.g., via brand awareness advertising) can be measured indirectly by sampling the market (e.g., via brand surveys). The environment of FIG. 1C introduces one technique for capturing engagement metrics when forming a predictive model for a marketplace.

FIG. 1C depicts an environment 1C00 for constructing and using a cross-channel predictive model using engagement metrics, according to some embodiments. As shown, the environment 1C00 shows how an engagement model 101 can be combined with the engagement continuum 140 of FIG. 1A. Specifically, the engagement model 101 receives inputs in the form of stimulation data (e.g., TV, print, direct mail, etc., as shown in stimulation 141) as well as input from engagement activities and/or engagement proxies (e.g., social site activity, reward registrations, etc., as shown in engagement 142). This latter class of inputs models consumer engagement. More specifically, as a consumer traverses through the engagement continuum 140, the consumer may form a brand awareness, and may form opinions (e.g., positive, negative, strong, weak, etc.). Engagement can be fostered by traditional media such as in-store promotions (e.g., “bricks”), or can be fostered by new media such as social networking sites, etc. (e.g., “clicks”). Engagement and opinions can be measured in various ways, irrespective of how the engagement was fostered and/or whether the opinions are positive or negative, or strong, or weak.

Brand surveys commonly contain quantitative data inasmuch as most companies collect data from consumers and/or prospects about the firm's brands, products, and competition. Such quantitative data can server as data points between stimulus and response (e.g., as shown, through engagement model 101). Capture of such quantitative data allows incorporation of such engagement metrics into rich mixed media models that serve to capture the effect of media on:
awareness;
perception;
sentiment; and, in some cases,
clicks, and/or other actions.

Further examples of such engagement variables include online activities (e.g., social media interaction, website click-through, click-on interactions and other online activities. Such engagement variables can be used as “lead indicators” of future sales activity. For example, in the consumer packaged goods space (e.g., low-cost goods such as toothpaste or toilet paper), most purchases occur using offline “brick-and-mortar” outlets where there is little to no technology to directly relate a particular sale to a particular individual. In such cases, analysis of various online activities can be used as a proxy for the purchase. For example, a loyalty card or reward program registration and/or a coupon download might be shown to correlate to specific sales activities or events. Such a proxy might provide quantitative evidence as to the efficacy of media spending.

During the course of prosecution of a mixed media advertising campaign, there emerge many engagement metrics that can be used to assess the marketplace. Results of brand surveys are but one species of a broad class of engagement metrics. Indeed, brand surveys can assess brand awareness, brand perception, brand sentiment, and action readiness, and the results of brand surveys can be used as quantitative proxies for the aforementioned. Additionally, other proxies are often available during the course of prosecution of a mixed media advertising campaign. Strictly as examples, proxies for consumer behavior that can be used as engagement metrics in predictive models include capturing aggregated responses such as:
a number of telephone calls to a telephone number referenced in a radio spot;
a number of coupons downloaded; and/or,
a number of inquiries pertaining to and adjacent product or service.

FIG. 1D depicts an environment 1D00 for practicing media spend optimization using a cross-channel predictive model. As an option, one or more instances of environment 1D00 or any aspect thereof may be implemented in the context of the architecture and functionality of the embodiments described herein.

One approach to advertising portfolio optimization uses marketing attributions and predictions determined from historical data. Analysis of the historical data can serve to infer relationships between marketing stimulations and responses. In some cases, the historical data comes from “online” outlets, and is comprised of individual user-level data, where a direct cause-effect relationship between stimulations and responses can be verified. However, “offline” marketing channels, such as television advertising, are of a nature such that indirect measurements are used when developing models used in media spend optimization. For example, stimuli are described as an aggregate (e.g., “TV spots on Prime Time News, Monday, Wednesday and Friday) that merely provide a description of an event or events as a time-series of marketing stimulations (e.g., weekly television advertising spends). Responses are also measured and/or presented in aggregate (e.g., weekly unit sales reports provided by the telephone sales center). Yet, correlations, and in some cases causality and inferences, between stimulations and responses can be determined via statistical methods.

As shown in FIG. 1D, stimuli 102 arise from a portfolio 103 of spends. The stimuli 102 comprise various “spots” or “placements” (e.g., TV spots, radio spots, print media mailer, web banner ads, etc.). The stimuli 102 are presented to the marketplace and undergo a plurality of marketplace dynamics 104 resulting in a set of responses 106 that are included in a set of measured responses 108. Generally, and as shown, at least one response measurement in the measured responses 108 is attempted for each stimulus in the portfolio 103. For example, a “TV Prime Time News” placement might be measured by a “Nielsen Household Share” metric.

In collecting historical data, any series of stimuli 102 from the portfolio 103 spends can be considered to be known stimuli 110, and any of the responses 106 that are observed and included in the measured responses 108 can be considered to be known responses 112. A learning model (e.g., learning model 116₁) can be formed using the historical data. The learning model 116₁ serves to predict a particular channel response from a particular channel's stimulation (e.g., see the predictor between the shown instances of stimuli 102 and responses 106). For example, if a radio spot from last Saturday and Sunday resulted in some number of calls to the broadcasted 1-800 number, then the learning model 116₁ can predict that additional radio spots next Saturday and Sunday might result in approximately the same number of calls to the broadcasted 1-800 number. Of course, there are often influences not included in such a model. For example, next Sunday might be Super Bowl Sunday, which might suggest that many people would be watching TV rather than listening to the radio. Such external factors can be included in a learning model, and incorporation of such external factors is further discussed below.

As earlier indicated, what is desired is a model that considers cross-channel effects even when direct measurements are not available. The simulated model 128 is such a model, and can be formed using any machine learning techniques and/or the operations shown in FIG. 1D. Specifically, the embodiment of FIG. 1D shows a technique where variations (e.g., mixes) of stimuli are used with the learning model 116₁ to capture predictions of what would happen if a particular portfolio variation (e.g., a mix of spends 111) were prosecuted. The learning model 116₁ produces a set of predictions (e.g., predictions 118₁, predictions 118₂, predictions 118₃, etc.), one set of predictions for each variation (e.g., variation 114₁, variation 114₂, variation 114₃, etc.). In this manner, various variations of stimuli 120 produce predicted responses 122, which are used in weighting and filtering operations at a predictive model 124 to generate a simulated model 128 that includes cross-channel predictive capabilities. In one or more embodiments, the aforementioned components and operations can be included in a cross-channel correlator 636₁, as shown.

The cross-channel predictive capabilities of the simulated model 128 facilitates making cross-channel predictions from a user-provided scenario (e.g., scenario 130). A user 105 can further use the simulated model 128 to generate a plurality of reports 132 (e.g., reports 132₁, reports 132₂, reports 132₃, etc.) using a particular user-provided scenario. Strictly as one example, a report can come in the form of an ROI report that quantifies the return on investment of the particular mix of spends specified by a user after considering cross-channel effects.

In addition to measuring the known responses 112 from the known stimuli 110, the effectiveness of stimuli on consumer engagement (awareness, sentiment, etc.) can also be measured (e.g., using engagement metrics), and can be included in models, which in turn can be used to optimize spending. An environment for practicing media spend optimization using engagement metrics is presently discussed.

FIG. 1E depicts an environment 1E00 for practicing media spend optimization using engagement metrics in a cross-channel predictive model, according to some embodiments. As shown, the learning model 116₂ comprises multiple predictors. Whereas the disclosure of FIG. 1D includes a discussion of a stimulus-response predictor 115, the learning model 116₂ includes two additional predictors, namely a stimulus-engagement predictor 117 and an engagement-response predictor 119.

The aforementioned predictors (e.g., stimulus-response predictor 115, stimulus-engagement predictor 117, and engagement-response predictor 119) can each form a model that is learned by applying any known machine learning techniques to combinations of the known stimuli 110, the known responses 112, and a set of engagement metrics 107. For example, a stimulus-response model can be formed using known stimuli 110 and known responses 112. Then the model can be used as a stimulus-response predictor 115 by inputting some particular stimulus and interpreting the output of the model as a prediction of how the modeled stimulus-response relationship would behave.

Similarly, an engagement-response model can be formed using the engagement metrics 107 and the known responses 112. Such an engagement-response model can be used as an engagement-response predictor 119 by inputting some particular set of engagement metrics and interpreting the output of the model as a prediction of how the modeled engagement-response relationship would behave.

Still further, a stimulus-engagement model can be formed using the known stimuli 110 and the engagement metrics 107. Then the stimulus-engagement model can be used as a stimulus-engagement predictor 117 by inputting some particular set of stimuli and interpreting the output of the model as a prediction of how the modeled stimulus-engagement relationship would behave.

The aforementioned models can be chained or cascaded. For example, two models where the output of a first model is the input of the second model can be chained or cascaded (e.g., see cascaded models 127 in FIG. 1C). For example, a stimulus-engagement model can be cascaded with an engagement-response model to predict a response from a given stimulus. Still further, the aforementioned models can be tiered. Multiple tiers of cascaded models can be formed of a collection of multiple sub-models.

In the environment 1E00, the sub-models nearer the inputs of the learning model 116₂ can serve as predictors of engagement variables as a function of media stimulation. The sub-models nearer the outputs of the learning model 116₂ can serve as predictors of responses or other conversion metrics (e.g., sales) as a function of engagement variables.

As such, the learning model 116₂ and the predictive model 124 (e.g., when combined with variations of stimuli 120) and can serve the media manager to predict or determine what media spending is expected to produce what engagement results. With the confidence of such predictions, the media manager can direct resources (e.g., spending) to achieve a desired outcome (e.g., higher awareness, improved sentiment, higher likelihood of action, higher unit or dollar volume of sales, etc.).

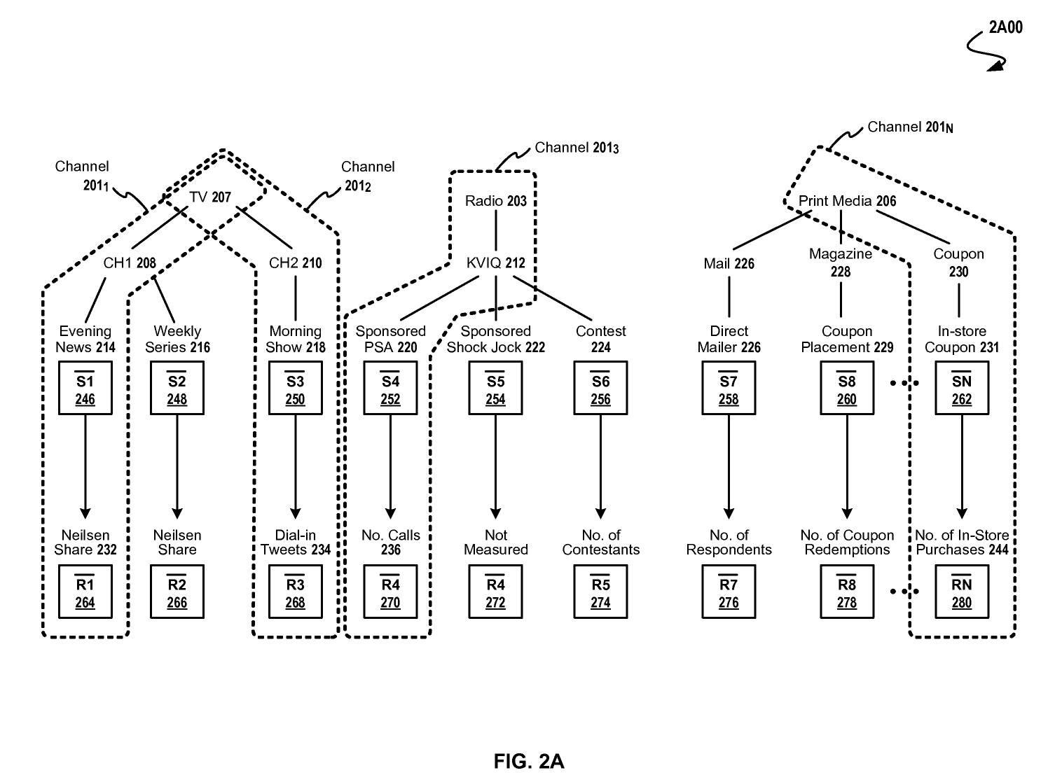

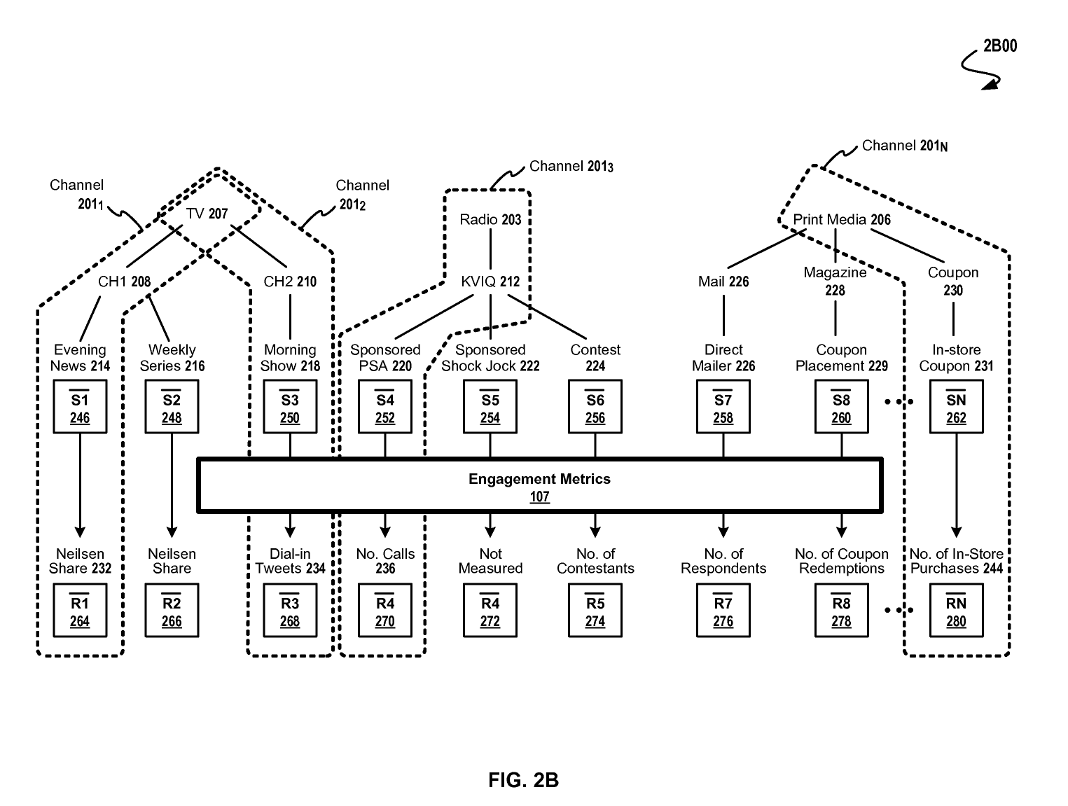

FIG. 2A presents a portfolio schematic 2A00 showing multiple channels as used in systems for media spend optimization using a cross-channel predictive model. As an option, one or more instances of portfolio schematic 2A00 or any aspect thereof may be implemented in the context of the architecture and functionality of the embodiments described herein. Also, the portfolio schematic 2A00 or any aspect thereof may be implemented in any desired environment.

As shown, the portfolio schematic 2A00 includes three types of media, namely TV 207, radio 203, and print media 206. Under each media type are shown one or more spends. TV 207 spends comprise stations named CH1 208 and CH2 210. Radio 203 spends comprise a station named KVIQ 212. Print media 206 spends comprise distribution through mail 226, magazine 228, and printed coupon 230. For each media shown, there is one or more stimulations (e.g., S1, S2, S3 . . . SN) and its respective response (e.g., R1, R2, R3 . . . RN). As shown, there is a one-to-one correspondence between a particular stimulus and its response. For example, the TV 207 spot for evening news 214 is depicted with stimulus S1 246, and has an associated response R1 264 (e.g., Neilsen share 232). Additional stimuli (e.g., S2 248, S3 250, S4 252, S5 254, S6 256, S7 258, S8 260, SN 262) and additional responses (e.g., R2 266, R3 268, R4 270, R5 272, R6 274, R7 276, R8 278, RN 280) are shown. The stimuli and responses discussed herein are often formed as a time-series of individual stimulations and responses, respectively. For notational convenience a time-series is given as a vector, such as the shown vector S1.

Continuing the discussion of this portfolio schematic 2A00, the media portfolio includes spends for TV 207 during the evening news 214, weekly series 216, and morning show 218. The media portfolio also includes radio 203 spends in the form of a sponsored public service announcement 220, a sponsored shock jock spot 222, and a contest 224. The media portfolio also includes print media 206 spends for a direct mailer 226, a coupon placement 229, and an in-store coupon 231, as shown.

The portfolio schematic 2A00 also shows a set of response measurements to be taken. As shown, channel 201₁ includes a measurement using Nielsen share 232, channel 201₂ includes a measurement using dial-in tweets 234, channel 201₃ includes a measurement using number of calls 236, and channel 201_{N} includes a measurement using number of in-store purchases 244.

FIG. 2B presents a portfolio schematic 2B00 showing multiple channels as used in systems for media spend optimization using engagement metrics in a cross-channel predictive model, according to some embodiments.

The portfolio schematic 2B00 includes stimulations and responses as discussed in the foregoing. Also shown is a set of engagement metrics 107. As depicted, the engagement metrics 107 may overlap with one or more channels (e.g., see channel 201₂, and see channel 201₃), or they may not overlap (e.g., see channel 201₁, and see channel 201_{N}). In some cases, the engagement metrics 107 are developed using a particular stimulus. For example, an engagement metric survey might pose a question, “Did you watch the ‘Morning Show’ on CH2 last night?” If the respondent answers affirmatively, then the survey might pose further questions to assess if the respondent had gained an awareness of the brand, and/or if the respondent had formed an opinion about the brand, and so on.

Given the aforementioned learning model (e.g., learning model 116₂) and predictors (e.g., stimulus-response predictor 115, stimulus-engagement predictor 117, and engagement-response predictor 119), a media portfolio manager might reach an insight that, for example, the “Morning Show” is particularly effective at developing brand awareness. Or, the media portfolio manager might reach an insight that, for example, the “Morning Show” is utterly ineffective at developing brand awareness. Spending on the “Morning Show” and related stimulus might be expanded (e.g., in the former case) or curtailed or even eliminated (e.g., in the latter case).

Various techniques as discussed herein can be used to synthesize a multi-channel campaign execution plan to be prosecuted over a time period, and such synthesis might employ a predictive model using engagement metrics in order to address goals of media spend optimization.

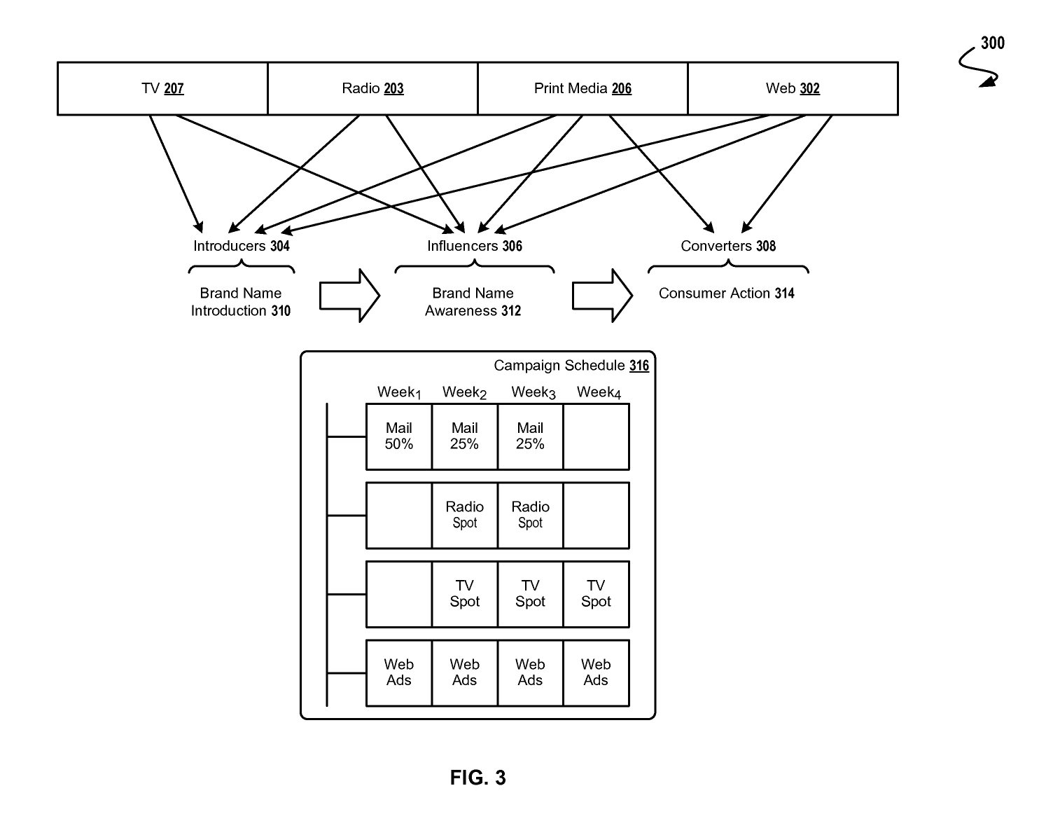

FIG. 3 depicts a multi-channel campaign execution plan 300 to be prosecuted using media spend optimization using engagement metrics in a cross-channel predictive model. As an option, one or more instances of the multi-channel campaign execution plan 300 or any aspect thereof may be implemented in the context of the architecture and functionality of the embodiments described herein. Also, the multi-channel campaign execution plan 300 or any aspect thereof may be implemented in any desired environment.

An advertising campaign might coordinate placements across many channels using many types of media. Coordination of media might include TV 207, radio 203, print media 206, web 302, and others. Any one of the available media types might be used as introducers 304 and/or as influencers 306 and/or as converters 308. Often certain marketing objectives (e.g., brand name introduction 310, brand name awareness 312, consumer action 314, etc.) can be met most efficiently using one or another particular type of media or combinations of media. For example, TV 207 is often used as an introducer (e.g., to create brand reach), and print media 206 is often used as an influencer (e.g., to transform brand awareness into some particular actions taken), and the web 302 is often used as a converter (e.g., when the actions taken culminate in a purchase).

In many cases, there is a delay between a particular spend and expectation of a respective response. For example, if a direct mail flyer is mailed on a Saturday evening, it would be expected that responses cannot occur any time before the following Monday. In other cases, an expected response can be obtained even after the marketing spend has been terminated. Such a delayed response or “halo period” can occur for many reasons (e.g., due to factors such as brand equity etc.).

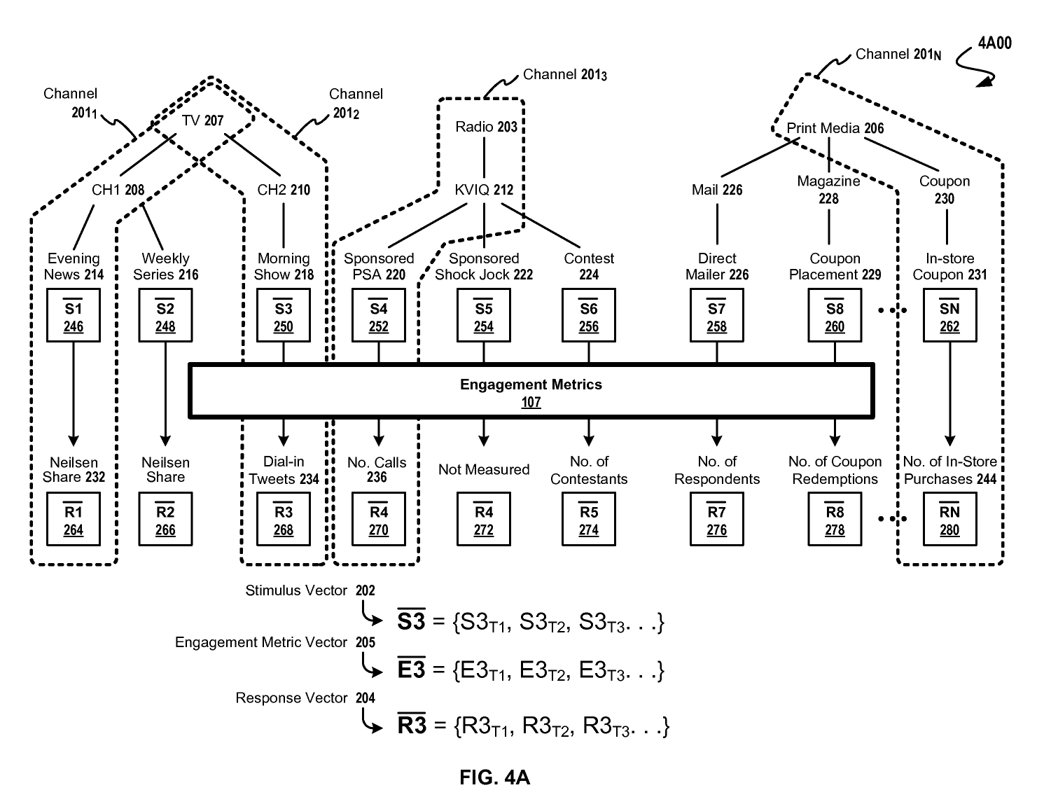

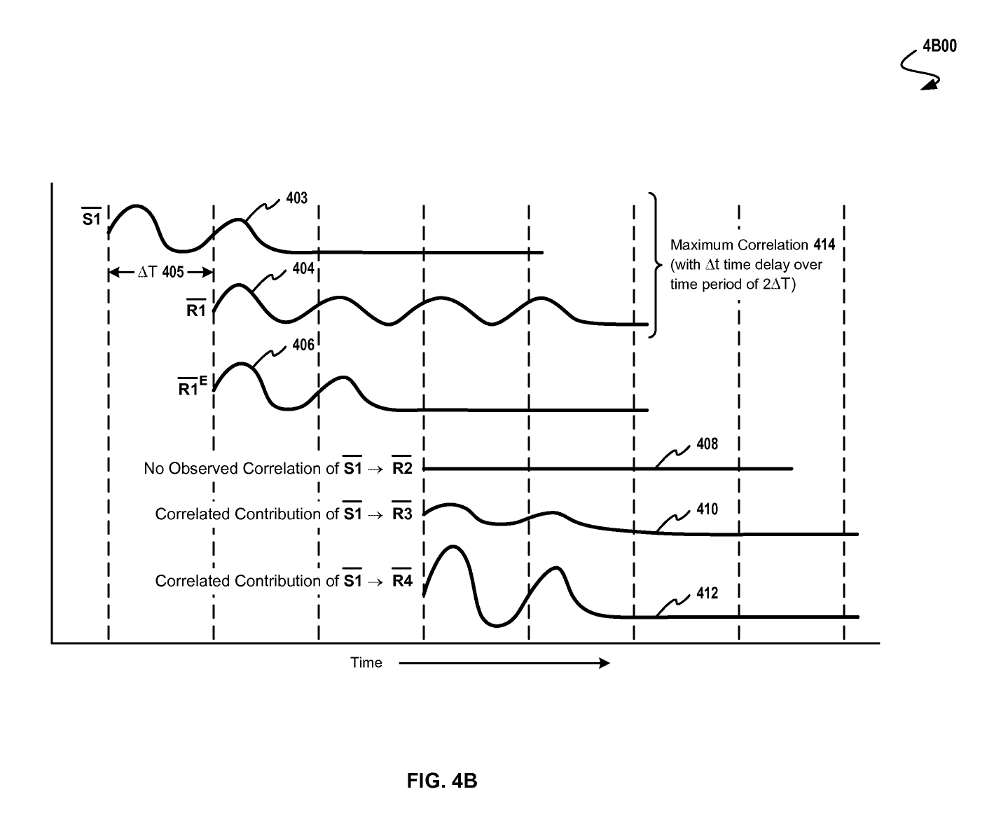

Modeling of such temporal factors can be considered when developing models. In certain models, temporal characteristics (e.g., delays) are present in a given pair of stimulus-response time-series (see FIG. 4A) and in some cases, delays can be automatically determined during correlation steps (see FIG. 4B).

As shown, the campaign schedule 316 staggers marketing actions over time in expectation of matching the spends to expected delays in response from earlier spends. For example, a mass mailing is undertaken at the earliest moment in the campaign (see Week₁) with the expectation of a mail system delay of a week or less. Then, one week later (see Week₂) TV and radio spots are run. During the prosecution of the campaign, a time-series of spends occurs, and a time-series of responses is observed. Such observed spends and responses can be codified (e.g., into a spreadsheet or a list or an array, etc.) and used as known stimuli 110 (e.g., in a time-series of stimulus scalars) and known responses 112 (e.g., in a time-series of response scalars).

FIG. 4A is a chart 4A00 depicting vectors formed from time-series of scalars as used in forming a cross-channel predictive model. As an option, one or more instances of vectors or any aspect thereof may be implemented in the context of the architecture and functionality of the embodiments described herein.

The shown vectors (e.g., stimulus vector 202, engagement metric vector 205, and response vector 204) are comprised of a time-series of data items (e.g., values, measurements). The time-series can be presented in a native time unit (e.g., weekly, daily) and can be apportioned over a different time unit. For example, stimulus S3 corresponds to a weekly spend for the “Morning Show”, even though the stimulus to be considered actually occurs daily (e.g., during the “Morning Show”). The weekly stimulus spend can be apportioned to a daily stimulus occurrence. In some situations, the time unit in a time-series can be granular (e.g., by the minute). Apportioning over time periods or time units can be performed using any known techniques. Vectors (e.g., instances of stimulus vector 202, instances of engagement metric vector 205, instances of response vector 204, etc.) can be formed from any time-series in any time units and can be apportioned to another time-series using any other time units.

FIG. 4B is a correlation chart 4B00 showing time-based and value-based correlations as used to form a cross-channel predictive model. As an option, one or more instances of correlation chart 4B00 or any aspect thereof may be implemented in the context of the architecture and functionality of the embodiments described herein. Also, the correlation chart 4B00 or any aspect thereof may be implemented in any desired environment.

A particular stimulus in a first marketing channel (e.g., S̅1̅) might produce measured results in the first marketing channel (e.g., R̅1̅). Additionally, a stimulus in a first marketing channel (e.g., S̅1̅) might produce results, or lack of results, as given by measured results in a different marketing channel (e.g., R̅3̅). Such correlation of results or lack of results can be automatically detected, and a scalar value representing the extent of correlation can be determined mathematically from any pair of vectors. In the discussions just below, the correlation of a time-series response vector is considered with respect to a time-series stimulus vector. Correlations can be positive (e.g., the time-series data moves in the same direction), or negative (e.g., the time-series data moves in the opposite direction), or zero (e.g., no correlation). Those skilled in the art will recognize there are many known-in-the-art techniques to correlate any pair of curves.

As shown, vector S̅1̅ is comprised of a series of changing values (e.g., depicted by the regression-fitted series covering the curve 403). The response R̅1̅ is shown as curve 404. As can be appreciated, even though the curve 404 is not identical to the curve 403 (e.g., it has undulations in the tail) the curve 404 is substantially value-correlated to curve 403. Maximum value correlation 414 occurs when curve 404 is time-shifted by a Δt 405 amount of time relative to curve 403 (see the Δt 405 graduations on the Time scale) and a time period of 2Δt is considered. The amount of correlation (see discussion below) and amount of time shift can be automatically determined. Cross-channel correlations are presented in Table 1.

TABLE 1
Cross-correlation examples

| Stimulus Channel →Cross- | |
|---|---|
| Channel | Description |
| S1→R2 | No correlation |
| S1→R3 | Correlates if time shifted and attenuated |
| S1→R4 | Correlates if time shifted and amplified |

In some cases, a correlation calculation can identify a negative correlation where an increase in a first channel causes a decrease in a second channel. Further, in some cases, a correlation calculation can identify an inverse correlation where a large increase in a first channel causes a small increase in a second channel. In still further cases, there can be no observed correlation (e.g., see curve 408), or in some cases correlation is increased when exogenous variables are considered (e.g., see curve R̅1̅^{E} 406).

In some cases a correlation calculation can hypothesize one or more causation effects. And in some cases correlation conditions are considered when calculating correlations such that a priori known conditions can be included (or excluded) from the correlation calculations.

Also, as can be appreciated, there is no correlation to the shown time-series R̅2̅. The curve 410 is substantially value-correlated (e.g., though scaled down) to curve 403, and is time-shifted by a second Δt amount of time relative to curve 403. The curve 412 is substantially value-correlated (e.g., though scaled up) to curve 403, and is time-shifted by a second Δt amount of time relative to curve 403.

The automatic detection can proceed autonomously. In some cases, correlation parameters are provided to handle specific correlation cases. In one case, the correlation between two time-series can be determined to a scalar value using Eq. 1:

$$r = \frac{n \sum xy - ( \sum x ) ( \sum y )}{\sqrt{n ( \sum {x}^{2} ) - {( \sum x )}^{2}} \sqrt{n ( \sum {y}^{2} ) - {( \sum y )}^{2}}} \qquad ( 1 )$$

where:

x represents components of a first time-series,

y represents components of a second time-series, and

n is the number of {x, y} pairs.

Other correlation techniques are possible, and a user might provide an indication and parameters associated with such alternative correlations. For example, parameters known as “AR”, “MA”, and “BW” are used in an autoregressive integrated moving average (ARIMA) model. Other parameters such as “FF” to characterize a forgetting factor, and “L” to characterize a length duration of the response variables can be included in correlation calculations.

In some cases, while modeling a time-series, not all the scalar values in the time-series are weighted equally. For example, more recent time-series data values found in the historical data are given a higher weight as compared to older ones. Various shapes of weights to overlay a time-series are possible, and one exemplary shape is the shape of an exponentially decaying model.

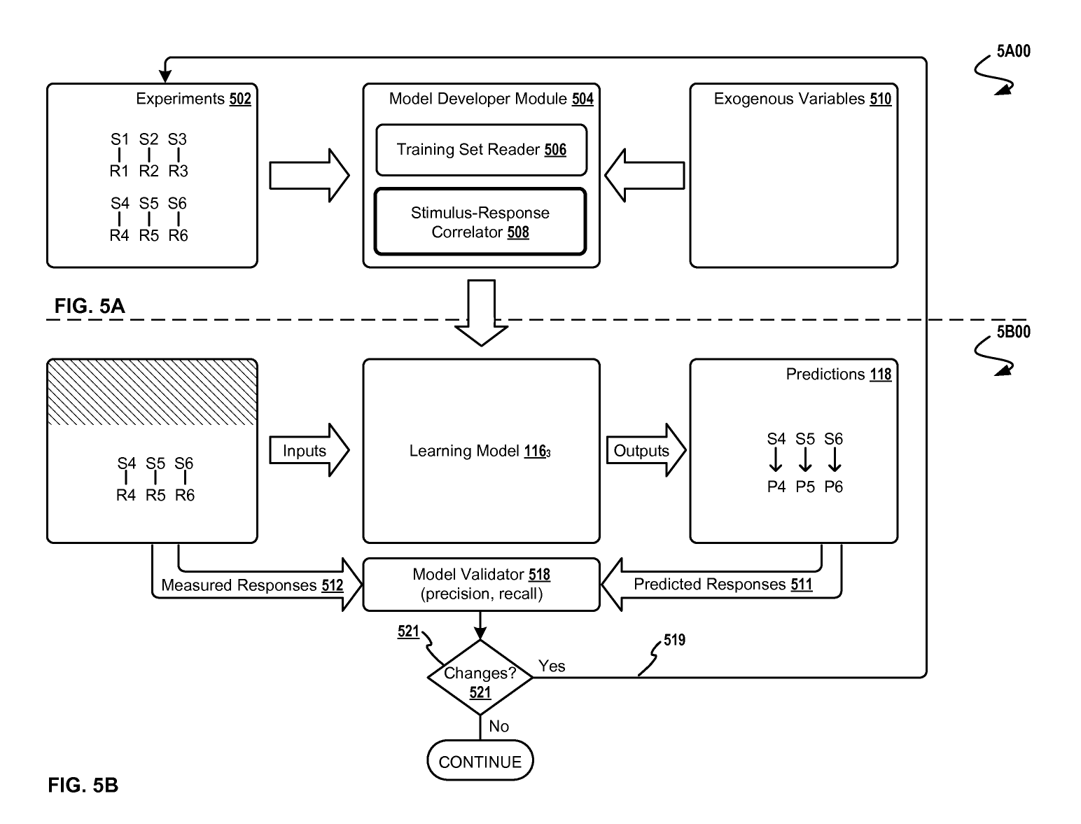

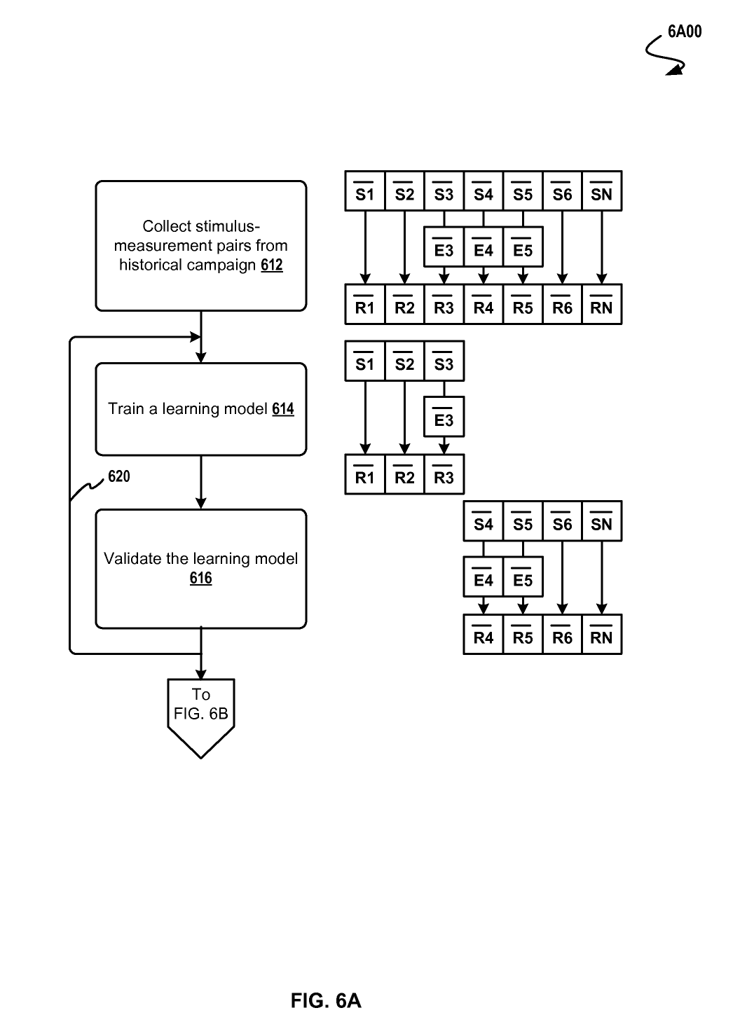

Such correlation techniques can be used by a stimulus-response correlator in the context of developing predictive models. Techniques for training predictive models are introduced in FIG. 5A. Techniques for validating predictive models are introduced in FIG. 5B.

FIG. 5A depicts an unsupervised model training flow 5A00 resulting in a baseline trained model. As an option, one or more instances of unsupervised model training flow 5A00 or any aspect thereof may be implemented in the context of the architecture and functionality of the embodiments described herein. Also, the unsupervised model training flow 5A00 or any aspect thereof may be implemented in any desired environment.

As shown, a model developer module 504 includes a training set reader 506 and a stimulus-response correlator 508. The model developer module 504 take as inputs a set of experiments 502 (e.g., pairs of stimulus and associated response measurements) and a set of exogenous variables 510. As earlier discussed, the exogenous variables 510 serve to eliminate or attenuate effects that are deemed to be independent from the stimulus (e.g., stimuli included in the experiments 502).

FIG. 5B depicts a supervised model validation flow 5B00 resulting in a learning model. As an option, one or more instances of supervised model validation flow 5B00 or any aspect thereof may be implemented in the context of the architecture and functionality of the embodiments described herein. Also, the supervised model validation flow 5B00 or any aspect thereof may be implemented in any desired environment.

The operations as shown and discussed as pertaining to FIG. 5A produce a learning model 116₃. The learning model 116₃ can be validated to achieve a confidence score, and/or precision and recall values. In one case, a portion of the experiments 502 are provided as inputs to the learning model and predictions 118 are captured. A model validator 518 compares the predicted responses 511 of the learning model 116₃ to the measured responses 512 from the response vectors captured empirically, and if a sufficient confidence and/or precision and/or recall is determined, then the learning model 116₃ is deemed validated. In some cases, decision 521 might indicate changes, and path 519 is taken for remedial steps. Remedial steps might include compiling additional experiments and/or performing correlations with different parameters and/or including or excluding exogenous variables, etc.

As described above, validations are performed on the learning model 116₃ using historical data itself (e.g., where both the stimulus and response are measured data) to ensure goodness of fit and prediction accuracy. In addition to model validation using the training dataset, additional validation steps are performed to check prediction accuracy and to ensure the model is not just doing a data fitting.

Model validation can occur at any moment in time. For example, the model developer module 504 can update the learning model 116₃ upon receipt of new input data. In such as case, a training model can be trained using training data up to the latest available date, which training model in turn can be used to predict the values in the historical data (e.g., data captured in the past). The error in the training model can be calculated. Statistical metrics can be employed to calculate errors in the training model.

As shown, model development and optimization is an iterative process (e.g., see decision 521 and path 519) involving updating the model with changes and/or adjustments and/or new or different exogenous variables (see discussion below) and/or newly captured stimulus/response data, etc. to make sure the model behaves within tolerances with respect to predictive statistic metrics (e.g., using MAPE, MAD, etc.) and descriptive statistics (e.g., using significance tests).

### Exogenous Variables

Use of exogenous variables might involve considering seasonality factors or other factors that are hypothesized to impact, or known to impact, the measured responses. For example, suppose the notion of seasonality is defined using quarterly time graduations and the measured data shows only one quarter (e.g., the 4^{th} quarter) from among a sequence of four quarters in which a significant deviation of a certain response is present in the measured data. In such a case, the exogenous variables 510 can define a variable that combines the 1^{st} through 3^{rd} quarters into one variable and the 4^{th} quarter in a separate variable. The model developer module 504, and/or its input functions, may determine that for a certain response, there is no period that behaves significantly differently from other periods, in which case the seasonality is removed or attenuated for that response.

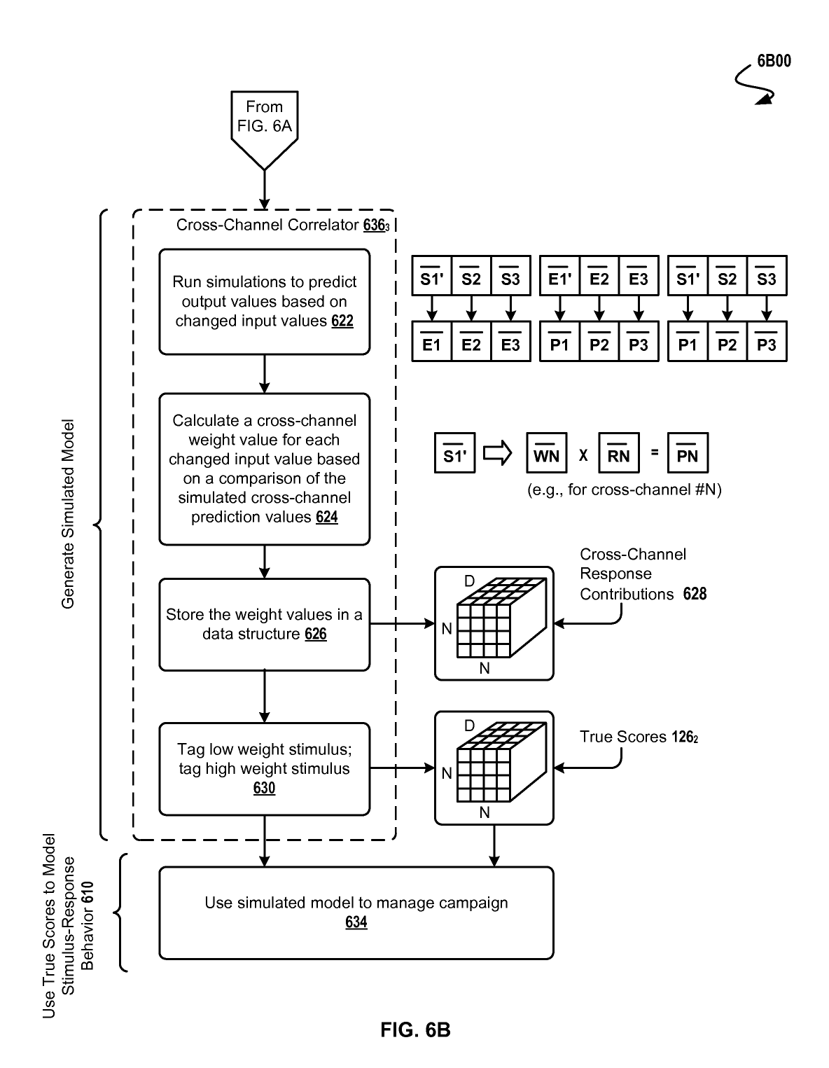

FIG. 6A and FIG. 6B depict a model development flow 6A00 and a simulation model development flow 6B00 used to develop simulation models for use in systems for media spend optimization using engagement metrics in a cross-channel predictive model, according to some embodiments. As an option, one or more instances of the flows or any aspect thereof may be implemented in the context of the architecture and functionality of the embodiments described herein.

As shown, stimulus vectors S1 through SN are collected, and response vectors R1 through RN are collected and organized into one-to-one pairings (see operation 612). In some cases, associated engagement metrics are also collected (e.g., E3 through E5). A portion of the collected pairs (e.g., pairs S1-R1 through S3-R3) can be used to train a learning model (see operation 614). A different portion of the collected pairs (e.g., pairs S4-R5 through S6-R6) can be used to validate the learning model (see operation 616). The processes of training and validating can be iterated (see path 620), perhaps using any of the model development techniques shown and described pertaining to FIG. 5A and FIG. 5B. Processing continues to operations depicted in FIG. 6B.

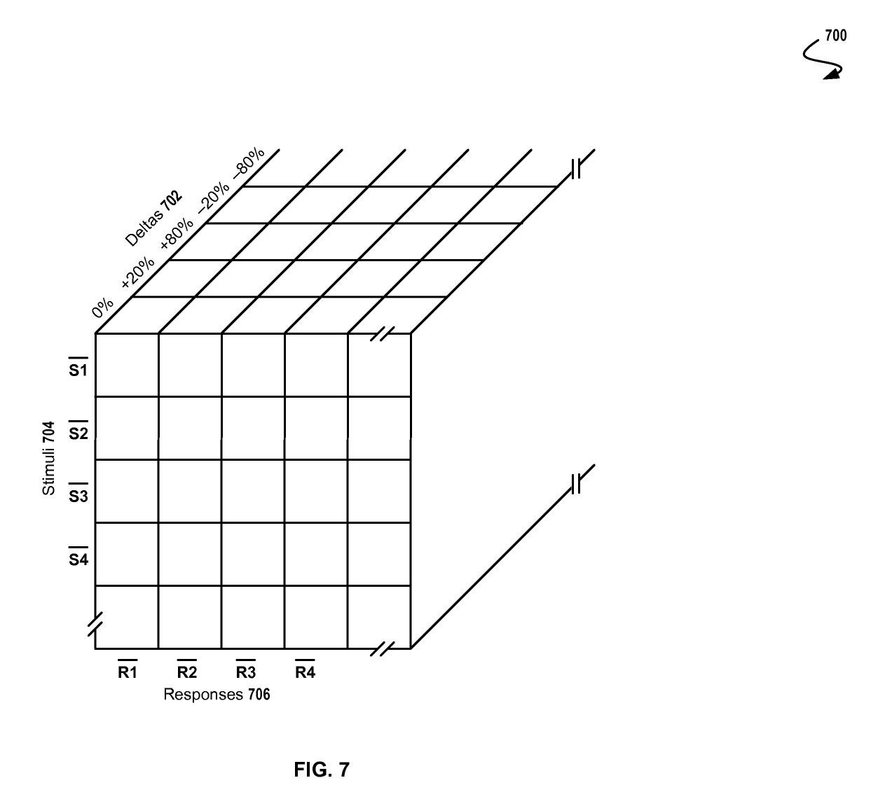

FIG. 6B depicts process steps (e.g., simulation model development flow 6B00) used in the generation of a simulation model from a training model. A cross-channel correlator 636₃ can be used to carry out some or all of the following steps:
Run simulations of varying stimuli using the learning model to predict output value changes (e.g., predicted responses 511) from the varied stimulation (see operation 622).
Using the simulations of operation 622, observe and quantify the changes in the responses in other channels (see operation 624). For example, and as shown, if only stimulus S1 is applied and varied across some range, the predicted response given as P2 can be captured. More specifically, a response in channel #2 (i.e., P2) to a stimulus variation in channel #1 (i.e., S1′) is deemed to be a cross-channel effect. In some cases, the effect in a cross channel can be modeled as a linear response, and a cross-channel weight (e.g., W) can be calculated and stored as a value. A weight value associated with the effect in channel #M from a stimulus in channel #N can be noted as W_{SNRM}.
Weight values covering all combinations of stimulus-response pairs can be stored in a data structure (see operation 626). As shown, such a data structure can be organized as a set of cross-channel response contributions 628 for each cross-channel simulation (e.g., the shown N by N two-dimensional array) plus as many additional simulated values as are performed over a sweep. For example, if a training model captured data from N channels, and a stimulus value was swept over the range [−100% through+100%] in 20% increments, the data structure would have a third dimension (e.g., “D” deep) for holding a weight value for each of the simulated variations of {-100%, −80%, −60%, −40%, −20%, 0%, +20%, +40%, +60%, +80%, and +100%}. A portion of such a data structure is given in FIG. 7.
Noisy values can be filtered out (see operation 630). Or, weight values that are above or below a particular threshold can be eliminated. The resulting true scores 126₂ can be used to predict the response of the entire system (e.g., multi-channel campaign) using a particular set of stimuli (see operation 634).

Having a simulation model that is populated with true scores (e.g., true scores 126₂) facilitates using a true score simulation model to predict the response of the entire system using a particular set of stimuli (e.g., a prophetic stimulus or prophetic scenario of stimuli). The true score model can be used to model stimulus-response behavior including cross-channel effects (see operation 610). For example, if an advertiser wants to know what would be the effect on coupon redemptions if the frequency of radio spots were increased, the model can be consulted as to the effect on coupon redemptions were the radio spots to be increased in frequency of occurrence. Also, the advertiser can use the true score simulation model to predict the overall campaign response (e.g., possibly broken down into individual channel contributions such as coupon redemptions). Or, an advertiser can carry out an experiment in the past. For example, if an advertiser wants to know what would have been the overall campaign effect of doubling last quarter's TV spots, the advertiser can use the true score simulation model to get an answer to what would have happened.

FIG. 7 depicts a true score data structure 700 used in systems for media spend optimization using engagement metrics in a cross-channel predictive model. As an option, one or more instances of true score data structure 700 or any aspect thereof may be implemented in the context of the architecture and functionality of the embodiments described herein. Also, the true score data structure 700 or any aspect thereof may be implemented in any desired environment.

Earlier figures depict a data structure to hold true scores (e.g., true scores 126₂), the true scores comprising weights to characterize channel-by-channel responses from a particular stimulus. As shown in FIG. 7, the true score data structure 700 comprises a stimuli ordinate 704, a responses abscissa 706, and a third dimension deltas 702. This organization provides storage space for selected weight values (e.g., true scores) to be stored, and each weight value is used to characterize channel-by-channel responses from a particular stimulus. More specifically, and as shown, an effectiveness value of stimulus S1 on cross-channel R2 can be held in such a data structure. Still more, any number of variations of S1, associated with effects on responses across various channels (e.g., R1, R2, R3, R4, etc.), can be modeled and stored. In the specific embodiment of FIG. 7, the variations shown correspond to an increase of 20%, an increase of 80%, a decrease of 20%, and a decrease of 80%.

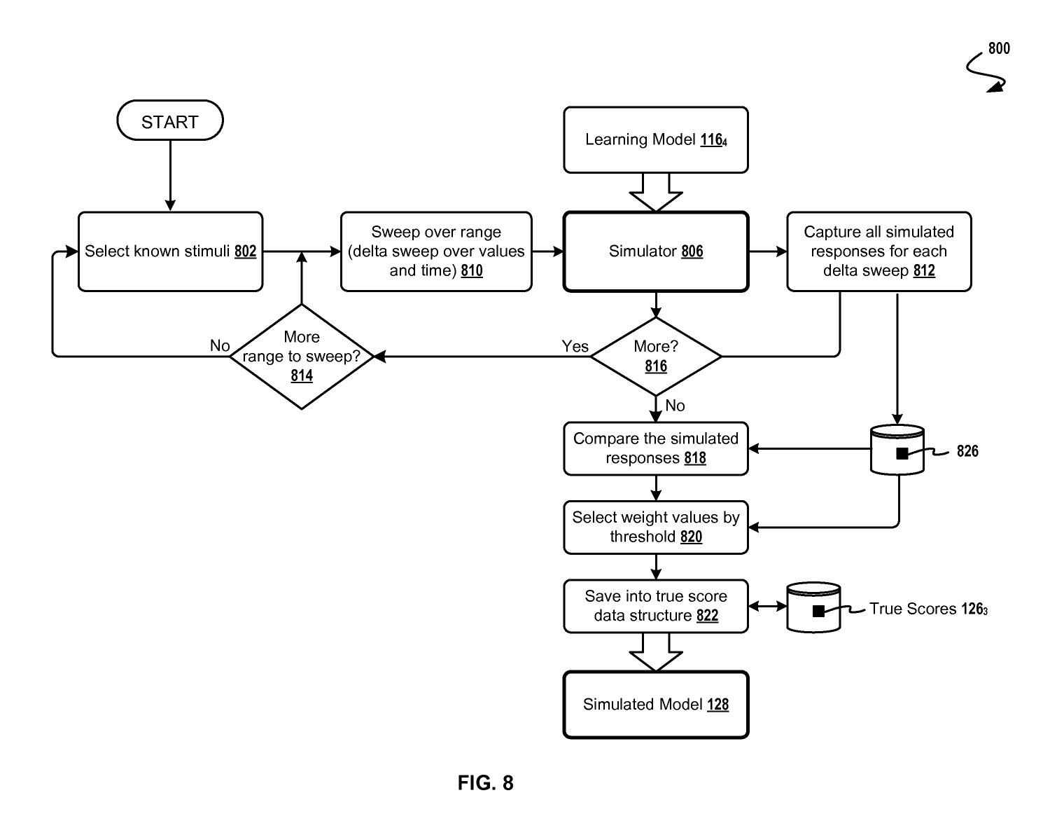

FIG. 8 is a block diagram of a subsystem 800 for populating a true score data structure as used in systems for media spend optimization using engagement metrics in a cross-channel predictive model. As an option, one or more instances of subsystem 800 or any aspect thereof may be implemented in the context of the architecture and functionality of the embodiments described herein. Also, the subsystem 800 or any aspect thereof may be implemented in any desired environment.

As shown, the system can commence when a particular known stimulus or set of stimuli are selected (see operation 802). Then a step to sweep over a range is entered (see operation 810). A particular set of delta sweep values (e.g., +20%, +40%, +80%, −20%, etc.) are selected and used as an input to a simulator 806, which in turn takes in a set of model parameters from a learning model 116₄. The simulator 806, along with the learning model 116₄, produces and captures a set of simulated responses 826 for each incremental step in the delta sweep (see operation 812). A series of simulations may comprise many selections of known stimuli, and a given stimulus may have a sweep range that comprises many steps, thus a decision 816 determines if there are more simulations to be performed. If so, processing continues to perform simulations over more sweep values or to perform simulations over more selected stimuli (see decision 814). When decision 816 deems that there are no more simulations to be performed, then a step is entered to observe outputs of the simulations to compare the simulation responses associated with a given set of stimuli (see operation 818). Specifically, the simulated responses 826 are observed, and weight values are calculated (e.g., using a linear apportioning). The weight values are checked against one or more thresholds (see operation 820), and some weight values (e.g., weight values smaller than a threshold) can be eliminated. Remaining weight values are saved in a data structure (e.g., true score data structure 700) as true scores 126₃ (see operation 822). The resulting data structure is used as a constituent to simulated model 128 (e.g., see true scores 126₁ in FIG. 1E).

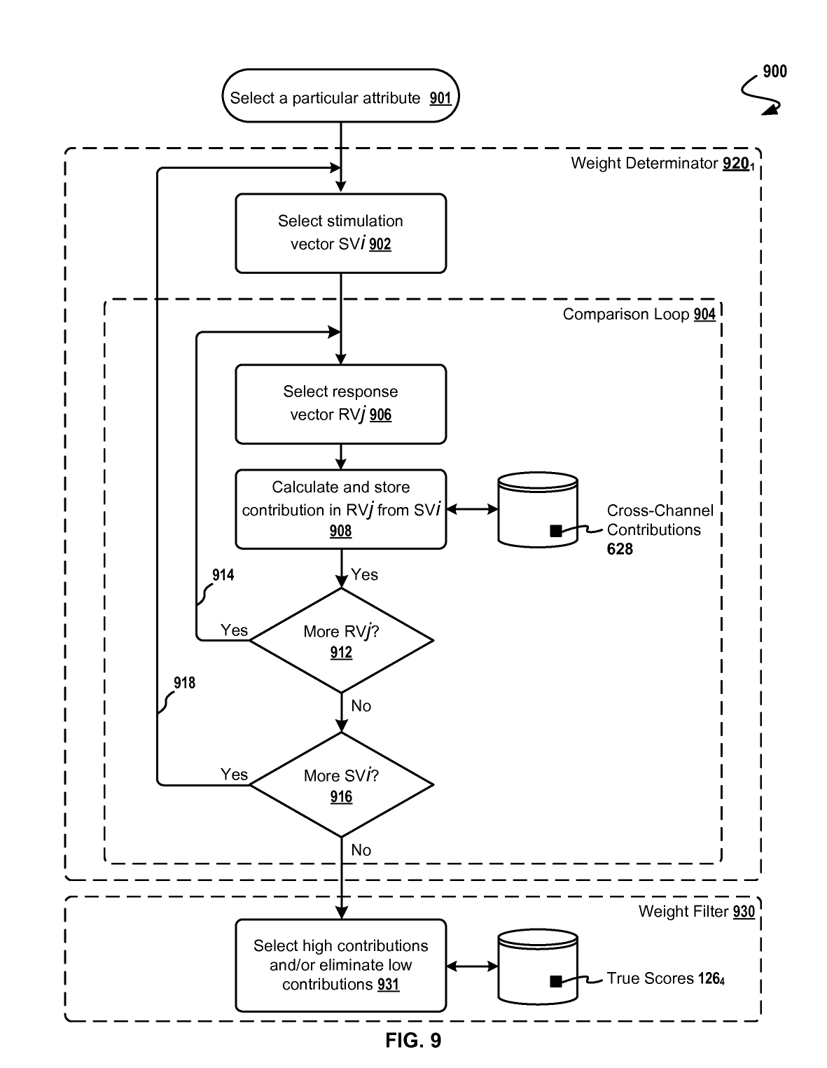

FIG. 9 is a block diagram of a subsystem 900 for calculating cross-channel contributions as used in systems for media spend optimization using engagement metrics in a cross-channel predivtive model, according to some embodiments. As an option, one or more instances of subsystem 900 or any aspect thereof may be implemented in the context of the architecture and functionality of the embodiments described herein. Also, the subsystem 900 or any aspect thereof may be implemented in any desired environment.

The above discussion of FIG. 8 describes steps to observe outputs of the simulations to compare the simulated responses given a set of associated stimuli. The simulated responses 826 are observed, and the contribution in a response channel to a particular stimulus is calculated. Specifically, and as shown in FIG. 9, the contribution in a response channel resulting from a particular stimulus can be determined by comparing the response with a delta variation in the particular stimulus to the response absent such a delta variation in the particular stimulus.

FIG. 9 depicts a sample partitioning of a technique to determine cross-channel effects (e.g., contributions) over all stimuli and over all channels over a selected attribute of one or more stimuli (e.g., spend, frequency, etc.). In this partitioning, the technique to determine cross-channel effects partitions certain operations into:
a first partition being a weight determinator 920₁, and
a second partition being a weight filter 930.
   Operations in the partitions cooperate in a manner that results in true scores 126₄.

Continuing with the discussion of FIG. 9, and as shown, an attribute is first selected (see operation 901) for calculating cross-channel contributions, which commences upon selecting a particular attribute (e.g., spend in a certain channel) then selecting a stimulation vector (e.g., SVi) that relates to the selected attribute (see operation 902). Strictly as examples, a particular stimulation vector SVi (e.g., placement of “TV spots on Prime Time News”) might be selected since it directly relates to a selected attribute (e.g., spend on TV spots). Or, a particular stimulation vector SVi (e.g., placements of “flysheet ads”) might be selected since it relates to another selected attribute (e.g., spend on newspaper spots).

The calculation of cross-channel contributions continues by entering a comparison loop 904 within which loop the following steps are taken:
Select a response vector RVj (see step 906). Response vectors RVj (where j is not equal to i) are deemed to be cross-channel response vectors. The cross-channel response vectors are used in the analysis of step 908.
Step 908 serves to calculate and store any contribution in response vector RVj resulting from stimulus vector SVi. As earlier indicated, a stimulus vector SVi might be a stimulus vector as a provided to the model, or a stimulus vector SVi might be a stimulus vector that has been apportioned by a sweep operation (e.g., see operation 810).
The result of comparison calculations can be stored in a data structure comprising simulated responses and cross-channel response contributions 628.
If there are more cross channels to consider (see decision 912), then path 914 is taken.
If here are more stimulus vectors to consider (see decision 916), then path 918 is taken.
When the comparison loop exits (e.g., there are no more stimulus vectors to consider), then processing proceeds to filtering operations (see operation 931).

The operation 931 serves to select-in (or eliminate-out) sufficiently high (or sufficiently low) contributions to generate true scores of contributions. The true scores 126₄ are stored in a data structure (e.g., true score data structure 700).

The subsystem 900 and the foregoing discussion thereto is merely one example of a technique to generate true scores of contributions. In this example, the contributions of the analyzed stimulus vectors are quantified. In another example, the contributions of a set of analyzed engagement metric vectors are quantified.

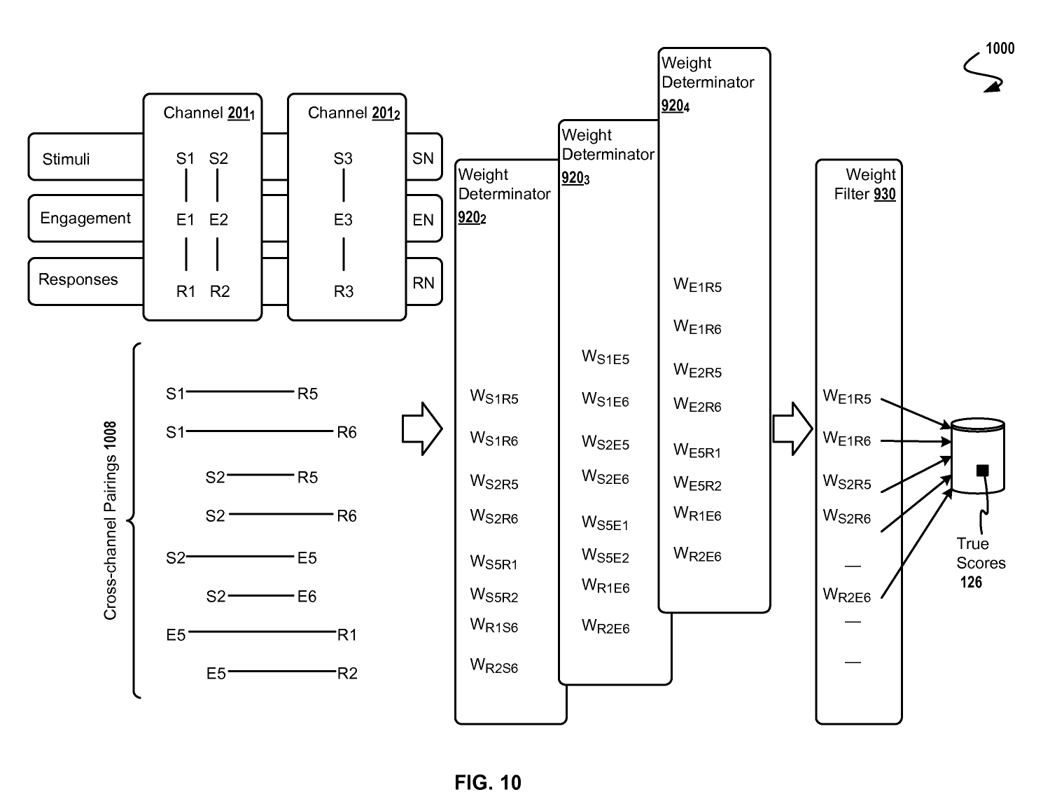

FIG. 10 is a data flow diagram 1000 for generating true scores using cross-channel engagement metrics and responses. A computer-implemented method can implement the data flow diagram 1000. The shown flow can be used in determining effectiveness (e.g., observed engagement metrics 107, observed responses 106) of marketing stimulations (e.g., stimuli 102) in a plurality of marketing channels (e.g., channel 201₁, channel 201₂, etc.) and at various stages of the engagement continuum 140 (e.g., see FIG. 1A). The flow proceeds upon receiving data comprising marketing stimulations (e.g., stimuli 102), engagement metrics (e.g., engagement metrics 107), and responses (e.g., responses 106). The marketing stimulations and respective measured engagement metrics and measured responses can be received as sets of cross-channel pairings 1008 (e.g., a stimulus-response pair, a stimulus-engagement pair, an engagement-response pair, etc.). In some cases, the stimulations, engagement metrics, and responses can be aggregated (e.g., a one-to-many correspondence of a particular stimulus to a set of observed responses, etc.).

Using the aforementioned cross-channel pairings 1008, a plurality of weight determinators 920 (e.g., weight determinator 920₂, weight determinator 920₃, and weight determinator 920₄) observes the changes in the output of a cross-channel pair as a result of the varying input of the cross-channel pair to determine a weight for the cross-channel pair. For example, weight determinator 920₃ can observe engagement metric E5 given stimulation S1 to determine a weight W_{S1E5}. In some cases, the cross-channel weights can be filtered (e.g., using a weight filter 930) so as to eliminate small cross-channel weights and/or to eliminate statistically insignificant cross-channel weights and/or to eliminate statistically outlying cross-channel weights, etc. The remaining cross-channel weights are stored in a data structure (e.g., true score data structure 700). The remaining cross-channel weights are used in calculating an effectiveness value of a particular one of the marketing stimulations. As an example, the effect of spending on TV spots might influence the effectiveness of a direct mail campaign.

Of course, the foregoing example does not limit the generality. The attributes of marketing stimulations to vary can come in the form of an advertising spend, a number of direct mail pieces, a number of TV spots, a number of radio spots, a number of web impressions, a number of coupons printed, etc. Further, the measured responses can come in the form of a number of calls into a call center after a broadcast, a number of clicks on an impression, a number of coupon redemptions, etc.

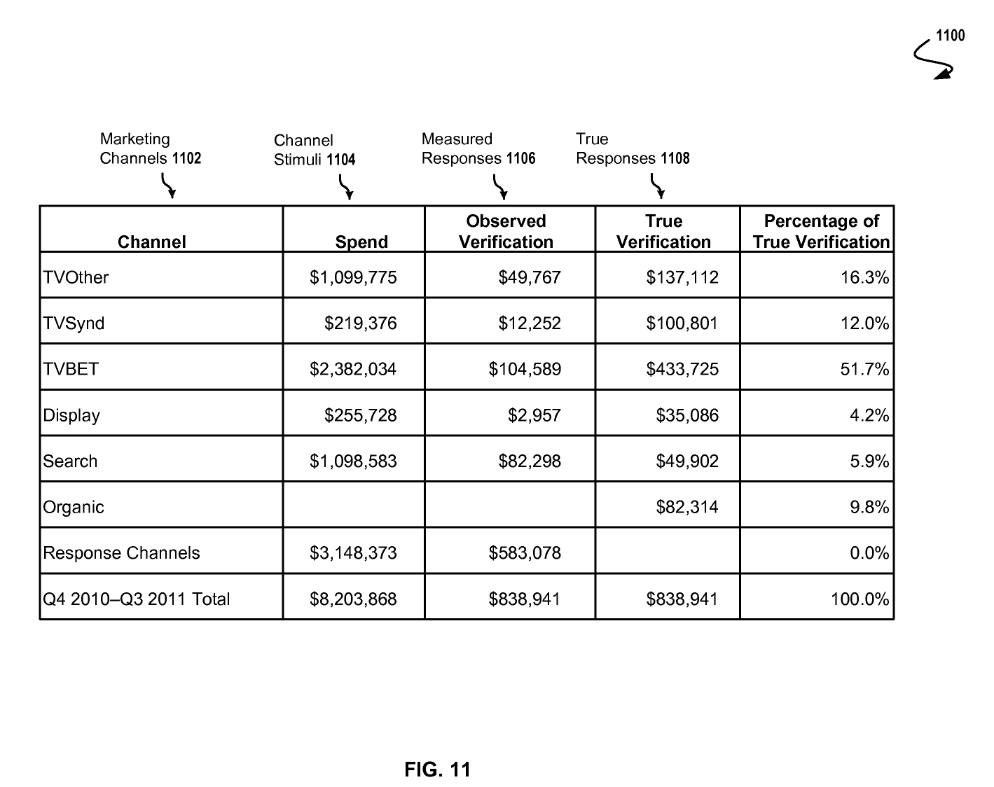

FIG. 11 depicts a true metrics report 1100 for practicing media spend optimization using engagement metrics in a cross-channel predictive model. The shown true metrics report 1100 depicts various measures of attribution (e.g., credit for a conversion) across multiple channels in a marketing campaign. In one or more embodiments, the true metrics report 1100 can be produced in environment 1E00 (e.g., an instance of the plurality of reports 132). In this embodiment of a true metrics report, a set of marketing channels 1102 are depicted, namely “TVOther”, “TVSynd”, “TVBET”, “Display”, “Search” (e.g., paid search), “Organic” (e.g., organic search), and “Response Channels” (e.g., a TV ad asking consumers to respond directly to a company, etc.). A set of channel stimuli 1104 for each channel (e.g., dollars spent in a respective channel) and a set of measured responses 1106 for each channel is also depicted. Further, in the shown true metrics report 1100, a set of true responses 1108 (calculated) and a set of calculated respective percentages of total responses is also depicted. The cross-channel true scores and other capabilities provided using the techniques described herein, in part, establish the true responses 1108 such that a true (e.g., quantitatively more accurate) attribution of the responses can be apportioned to the marketing channels 1102.

For example, referring to the true metrics report 1100, the largest value (e.g., $583,078) of the measured responses 1106 is attributed to “Response Channels”. In this example, no portion of measured responses 1106 is attributed to “Organic” (e.g., self-stimulation, organic search, etc.). In legacy approaches, this attribution can result from the relative ability (or inability) to measure a response in a given channel. For example, a stimulus-response correlation is readily observed in the “Response Channels” (e.g., the consumer calls the company upon seeing the TV spot), but difficult to observe in the “Organic” search channels (e.g., the consumer clicks a link from search results). Legacy approaches also don't account for cross-channels effects and engagement activity that can lead to (e.g., through the engagement continuum 140) to a measured response (e.g., in “Response Channels”, “Search” channels, etc.).

Using the techniques described herein and the output of true responses 1108 in true metrics report 1100, a more accurate attribution is provided. Specifically, the true responses 1108 reveal that no responses can be attributed to the “Response Channels”, even with a large percentage of measured responses (e.g., conversions) occurring in that channel. Rather, the true responses 1108 indicate that the measured responses 1106 underestimated the contribution of several channels. For example, the “TVBET” channel increased from a measured response of $104,589 (e.g., 12.5% of total, not shown) to a true response of $433,725 (e.g., 51.7% of total). Also, the “Organic” search channel increased from a measured response of $0 to a true response of $82,314 (e.g., 9.8% of total). Given the information provided by the true metrics report 1100, and other results provided by the techniques disclosed herein, the media manager can more effectively direct resources (e.g., channel spending) to achieve a desired outcome (e.g., higher awareness, improved sentiment, higher likelihood of action, higher unit or dollar volume of sales, etc.).

### Additional Practical Application Examples

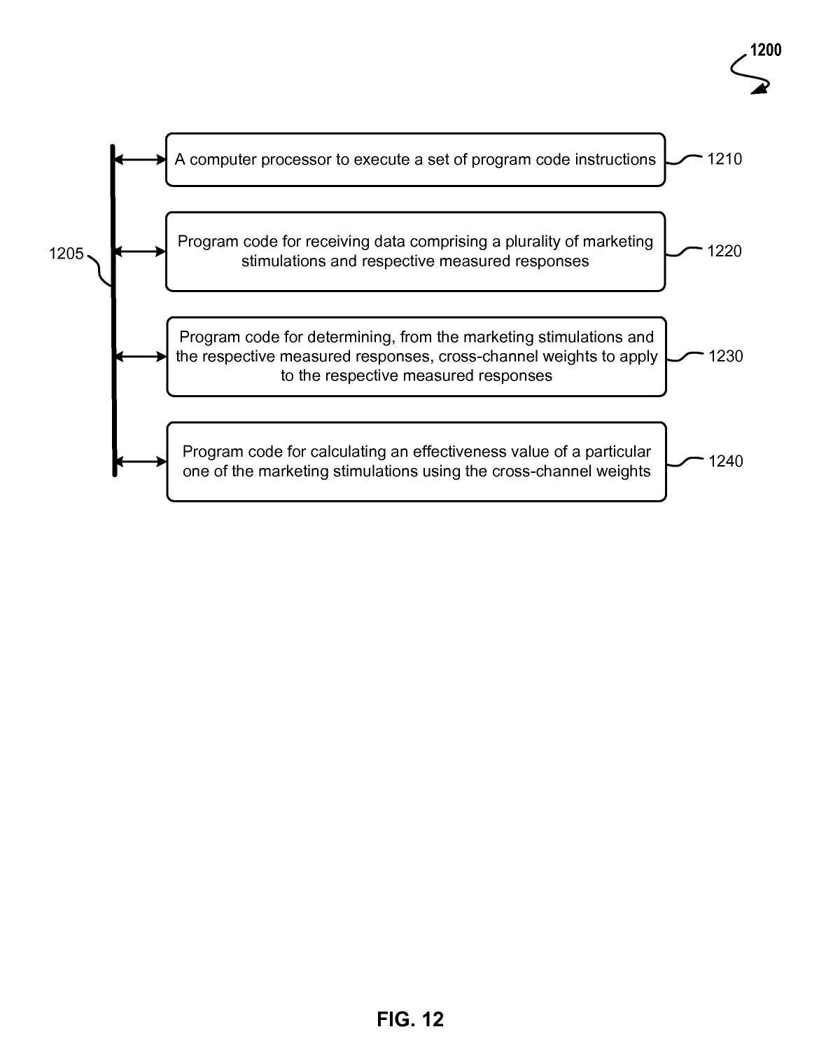

FIG. 12 is a block diagram of a system 1200 for optimizing media spend using a cross-channel predictive model, according to some embodiments. As an option, the system 1200 may be implemented in the context of the architecture and functionality of the embodiments described herein. Of course, however, the system 1200 or any operation therein may be carried out in any desired environment.

As shown, system 1200 comprises at least one processor and at least one memory, the memory serving to store program instructions associated with the operations of the system. As shown, an operation can be implemented in whole or in part using program instructions accessible by a module. The modules are connected to a communication path 1205, and any operation can communicate with other operations over communication path 1205. The modules of the system can, individually or in combination, perform method operations within system 1200. Any operations performed within system 1200 may be performed in any order unless as may be specified in the claims. The embodiment of FIG. 12 implements a portion of a computer system, shown as system 1200, comprising a computer processor to execute a set of program code instructions (see module 1210) and modules for accessing memory to hold program code instructions to perform: receiving data comprising a plurality of marketing stimulations and respective measured responses (see module 1220); determining, from the marketing stimulations and the respective measured responses, cross-channel weights to apply to the respective measured responses (see module 1230); and calculating an effectiveness value of a particular one of the marketing stimulations using the cross-channel weights (see module 1240).

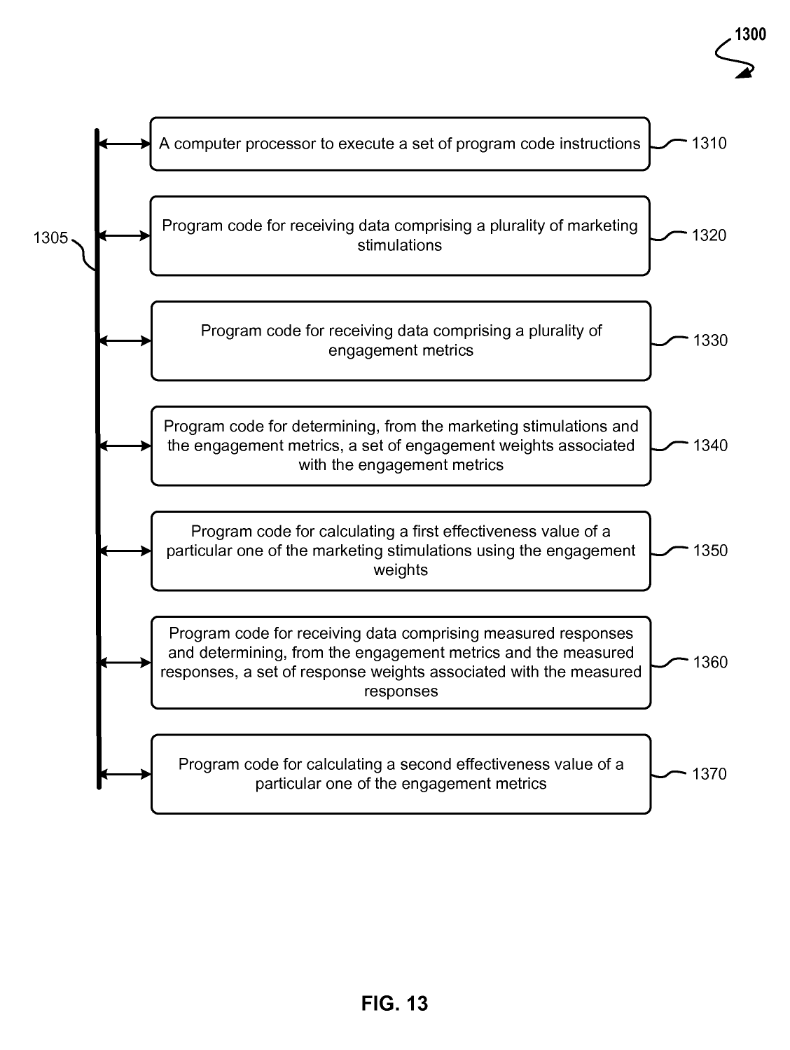

FIG. 13 is a block diagram of a system 1300 for media spend optimization using engagement metrics in a cross-channel predictive model. As an option, the system 1300 may be implemented in the context of the architecture and functionality of the embodiments described herein. Of course, however, the system 1300 or any operation therein may be carried out in any desired environment.

As shown, system 1300 comprises at least one processor and at least one memory, the memory serving to store program instructions associated with the operations of the system. As shown, an operation can be implemented in whole or in part using program instructions accessible by a module. The modules are connected to a communication path 1305, and any operation can communicate with other operations over communication path 1305. The modules of the system can, individually or in combination, perform method operations within system 1300. Any operations performed within system 1300 may be performed in any order unless as may be specified in the claims. The embodiment of FIG. 13 implements a portion of a computer system, shown as system 1300, comprising a computer processor to execute a set of program code instructions (see module 1310) and modules for accessing memory to hold program code instructions to perform: receiving data comprising a plurality of marketing stimulations (see module 1320); receiving data comprising a plurality of engagement metrics (see module 1330); determining, from the marketing stimulations and the engagement metrics, a set of engagement weights associated with the engagement metrics (see module 1340); and calculating a first effectiveness value of a particular one of the marketing stimulations using the engagement weights (see module 1350). Various embodiments include other operations, such as: receiving data comprising measured responses and determining, from the engagement metrics and the measured responses, a set of response weights associated with the measured responses (see operation 1360). The response weights can be used for calculating a second effectiveness value of a particular one of the engagement metrics (see operation 1370).

### System Architecture Overview

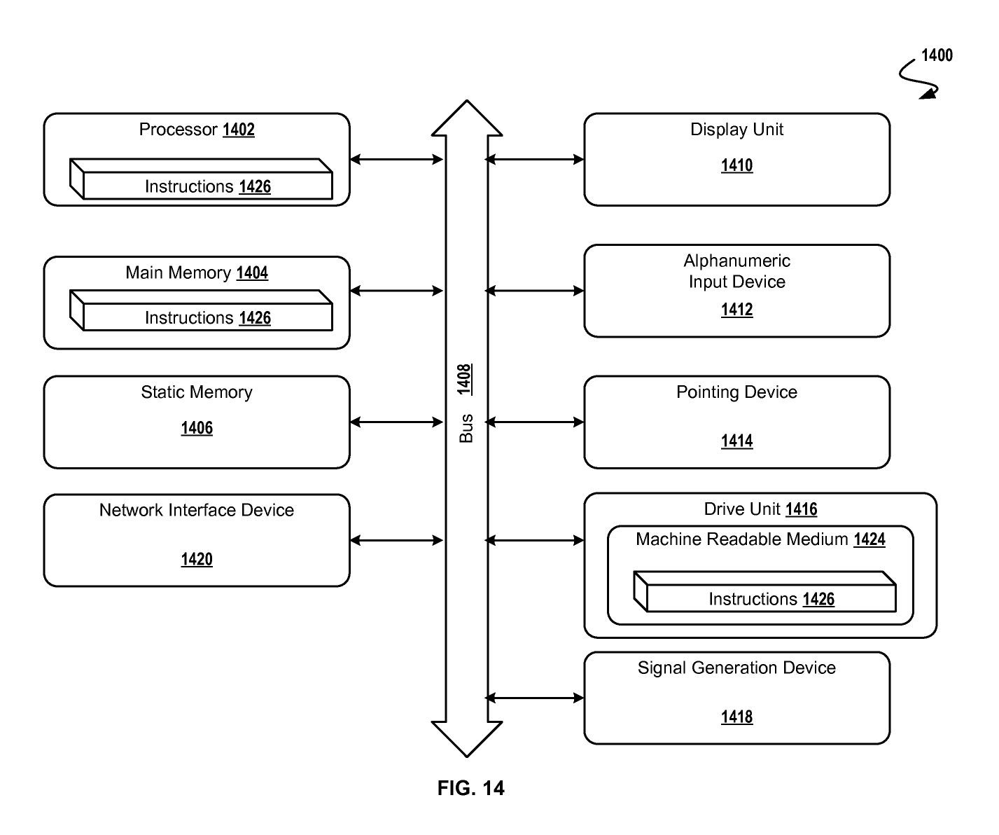

FIG. 14 depicts a block diagram of an instance of a computer system suitable for implementing an embodiment of the present disclosure. Specifically, FIG. 14 depicts a diagrammatic representation of a machine in the exemplary form of a computer system 1400 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1400 includes a processor 1402, a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 14 14 (e.g., a keyboard), a cursor control device 1414 (e.g., a mouse), a disk drive unit 1416, a signal generation device 1418 (e.g., a speaker), and a network interface device 1420.

The disk drive unit 1416 includes a machine-readable medium 1424 on which is stored a set of instructions (i.e., software) 1426 embodying any one, or all, of the methodologies described above. The software 1426 is also shown to reside, completely or at least partially, within the main memory 1404 and/or within the processor 1402. The software 1426 may further be transmitted or received via the network interface device 1420.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as a processor 1402.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than restrictive sense.

What is claimed is:

1. A system comprising:
a cross-channel correlator to receive data comprising a plurality of marketing stimulations and to receive data comprising a plurality of engagement metrics;
a weight determinator to determine from the marketing stimulations and the engagement metrics, a set of engagement weights associated with respective instances of the engagement metrics; and
a weight filter to calculate a first effectiveness value of a particular one of the marketing stimulations using the engagement weights.

2. The system of claim 1, wherein the cross-channel correlator is configurable to receive data comprising measured responses, and wherein the weight determinator is configurable to determine from the engagement metrics and the measured responses, a set of response weights associated with the measured responses.

3. The system of claim 2, wherein the weight filter is configurable to calculate a second effectiveness value of a particular one of the engagement metrics using the response weights.

4. The system of claim 2, further comprising a learning model formed from the marketing stimulations, the engagement metrics, and the measured responses.

5. The system of claim 4, wherein the learning model comprises a stimulus-response predictor, a stimulus-engagement predictor, and an engagement-response predictor.

6. The system of claim 4, wherein the learning model is configurable to predict a portion of a response in a second channel resulting from a stimulus in a first channel.

7. The system of claim 4, wherein the learning model is configurable to run a plurality of simulations to predict a portion of a response in a second channel resulting from a stimulus in a first channel.

8. The system of claim 7, wherein the learning model is configurable to vary the stimulus in the first channel and observe the response in the second channel for individual ones of the plurality of simulations.

9. The system of claim 4, further comprising a simulated model.

10. The system of claim 9, wherein the simulated model is configurable to generate one or more reports from a user scenario.

11. The system of claim 1, wherein the cross-channel correlator is configurable to determine a portion of aggregate responses that is not attributed to an aggregate stimuli.

12. The system of claim 1, wherein the marketing stimulations comprise at least one of, an advertising spend, a number of direct mail pieces, a number of TV spots, a number of radio spots, a number of web impressions, and a number of coupons printed.

13. A method comprising:
receiving, by a computer, first data records comprising a plurality of marketing stimulations;
receiving second data records comprising a plurality of engagement metrics;
determining, from the marketing stimulations and the engagement metrics, a set of engagement weights associated with the engagement metrics; and
calculating a first effectiveness value of a particular one of the marketing stimulations using the engagement weights.

14. The method of claim 13, further comprising:
receiving third data records comprising measured responses; and
determining, from the engagement metrics and the measured responses, a set of response weights associated with the measured responses.

15. The method of claim 14, further comprising calculating a second effectiveness value of a particular one of the engagement metrics using the response weights.

16. The method of claim 14, further comprising processing the marketing stimulations, the engagement metrics, and the measured responses to form a learning model.

17. The method of claim 16, wherein the learning model comprises a stimulus-response predictor, a stimulus-engagement predictor, and an engagement-response predictor.

18. The method of claim 16, further comprising predicting a portion of a response in a second channel resulting from a stimulus in a first channel.

19. The method of claim 16, wherein predicting a portion of a response in a second channel resulting from a stimulus in a first channel comprises running a plurality of simulations.

20. The method of claim 19, wherein individual ones of the plurality of simulations comprise varying the stimulus in the first channel and observing the response in the second channel.

21. The method of claim 16, further comprising outputting a simulated model.

22. The method of claim 21, further comprising generating one or more reports from a user scenario.

23. The method of claim 13, further comprising determining a portion of aggregate responses that is not attributed to an aggregate stimuli.

24. The method of claim 13, wherein the marketing stimulations comprise at least one of, an advertising spend, a number of direct mail pieces, a number of TV spots, a number of radio spots, a number of web impressions, and a number of coupons printed.

25. A computer program product embodied in a non-transitory computer readable medium, the computer readable medium having stored thereon a sequence of instructions which, when executed by a processor causes the processor to execute a process, the process comprising:
receiving data comprising a plurality of marketing stimulations;
receiving data comprising a plurality of engagement metrics;
determining, from the marketing stimulations and the engagement metrics, a set of engagement weights associated with the engagement metrics; and
calculating a first effectiveness value of a particular one of the marketing stimulations using the engagement weights.

26. The computer program product of claim 25, further comprising instructions for:
receiving data comprising measured responses; and
determining, from the engagement metrics and the measured responses, a set of response weights associated with the measured responses.
